(19) United States
(12) Patent Application Publication
(10) Pub. No.: US 2011/0190933 A1
(43) Pub. Date: Aug. 4, 2011

(54) Robotic Vehicle

(76) Inventors: Andrew Shein, Winchester, MA (US); Lee F. Sword, Hollis, NH (US)

(21) Appl. No.: 12/696,795

(22) Filed: Jan. 29, 2010

(51) Int. Cl. G05B 15/00

(52) U.S. Cl. 700/258; 901/1

(57) ABSTRACT

A mobile robot that includes a chassis, a drive system disposed on the chassis and configured to maneuver the robot over a work surface, a deck system, and a control system connected to the drive system and the deck system. The deck system includes a payload deck configured to receive a removable payload and a deck shifter configured to move the payload deck relative to the chassis. The control system includes a control arbitration system and a behavior system in communication with each other. The behavior system executes a behavior that evaluates and provides an outcome evaluation on a predicted outcome of a robot command. The control arbitration system selects and executes a robot command based at least in part on the outcome evaluation.

### STATEMENT AS TO FEDERALLY SPONSORED RESEARCH

This invention was in part with Government support under contract N41756-06-C-5512 awarded by the Technical Support Working Group of the Department of Defense. The Government may have certain rights in the invention.

### TECHNICAL FIELD

This disclosure relates to robotic vehicles.

### BACKGROUND

A new generation of robotic systems and tools is required to meet the increasing terrorist threat in the US and abroad. The lack of adaptability and limited capability of existing remote controlled systems available to Hazardous/First Response/Explosive Ordnance Disposal (EOD) teams has frustrated many teams worldwide. The unique and often dangerous tasks associated with the first responder mission require personnel to make quick decisions and often adapt their tools in the field to combat a variety of threats. The tools must be readily available, robust, and yet still provide surgical precision when required.

### SUMMARY

One aspect of the disclosure provides a mobile robot that includes a chassis, a drive system disposed on the chassis and configured to maneuver the robot over a work surface, a deck system, and a control system connected to the drive system and the deck system. The deck system includes a payload deck configured to receive a removable payload and a deck shifter configured to move the payload deck relative to the chassis. The control system includes a control arbitration system and a behavior system in communication with each other. The behavior system executes an anti-tip behavior configured to evaluate and provide an outcome evaluation on a predicted outcome of a robot command. The control arbitration system selects and executes a robot command based at least in part on the outcome evaluation. The anti-tip behavior evaluates the predicted outcome based on a robot tip-over criteria.

In some implementations, the anti-tip behavior determines a payload deck position relative to the chassis and provides the outcome evaluation based at least in part on the payload deck position. The anti-tip behavior may determine a position of a center of gravity of the payload deck relative to a center of gravity of the chassis and provide the outcome evaluation based at least in part on the position of the center of gravity of the payload deck. In some examples, the anti-tip behavior determines a position of a center of gravity of the entire robot relative to an operating envelope, and provides the outcome evaluation based at least in part on the position of the center of gravity of the entire robot.

The drive system, in some implementations, includes a skid steer drive system disposed on the chassis, which has a leading end, a trailing end, and a center of gravity therebetween. The drive system also includes right and left driven flippers disposed on corresponding sides of the chassis. Each flipper has a pivot end, a distal end, and a center of gravity therebetween. Each flipper pivots about a first pivot axis common with a drive axis at the leading end of the chassis. The lateral extents between the distal ends of the flippers and the trailing ends of the skid steer drive system defines the operating envelope.

The deck shifter may include a linkage having a pivot end, a distal end, and a center of gravity therebetween. The linkage pivots about a second pivot axis substantially at the leading end of the chassis. The payload deck has a mid pivot point, a leading end and a trailing end, and a center of gravity between the two ends. The payload deck pivots about a third pivot axis substantially at the distal end of the linkage. The anti-tip behavior monitors the centers of gravity of the chassis, the flippers, the linkage, the payload deck, and any received payloads to determine the center of gravity of the entire robot.

In some implementations, the anti-tip behavior includes one or more modes configured to maintain stability of the robot and/or influence which commands are combined for an overall command of the robot. A stop-priority mode prevents movement of the center of gravity of the entire robot outside of the operating envelope. In some examples, the stop-priority mode prevents movement of the center of gravity of the entire robot inside a threshold distance of a boundary of the operating envelope. A flipper-priority mode of the anti-tip behavior maintains the center of gravity of the entire robot inside the operating envelope when a robot command moves the flippers and thus alters the operating envelope. A center-of-gravity-priority mode of the anti-tip behavior alters the operating envelope by pivoting the flippers with respect to the chassis to maintain the center of gravity of the entire robot inside the operating envelope.

The behavior system may execute a payload manager behavior that reports received payloads to the control system. For example, the payload deck may include connection points for both a payload power link and a payload communication link. The payload manager may report which connection points a payload is received on and which payload communication link the received payload will use for communication. The payload deck may include multiple payload connection pads positioned to accommodate selective connection of multiple payload units to the payload deck. Each connection pad includes connection points for both payload power and payload communication.

In some implementations, the control system includes at least one control arbiter controlling the drive system and at least one control arbiter controlling the deck system. Multiple applications are in communication with the control arbiters. Each application includes a robot controller in communication with the control arbiters, an action selection engine in communication with robot controller, at least one behavior in communication with the action selection engine, and at least one action model in communication with the action selection engine. The action selection engine periodically executes an action selection cycle to generate an overall command which is sent to the robot controller for execution on the robot resources. Each action model models at least one of the robot resources and has at least one action space. A robot manager communicates with the applications and the control arbiters. The robot manger implements an application priority policy for determining which application has exclusive control of any one or more of the robot resources at a given time. The action selection cycle includes selecting a command for each action space of each action model, generating the single overall command based on the accumulated commands for each action model, and sending the overall command to the robot controller.

In some implementations, the action selection engine accumulates the outcome evaluations for each action space and selects a winning outcome for each action space. The action selection engine selects a command corresponding to the winning outcome for each action space. The action model may provide the heuristic search. Preferably, the action selection engine sequentially processes each action model in a predetermined order and each action space within each action model in a predetermined order. The action selection engine select a command for each action space by selecting a corresponding winning outcome based on the outcome evaluations. The outcome evaluations are weighted according to weights associated with each behavior. The action selection engine may use the winning outcomes of any preceding action spaces when selecting the winning outcome for each action space. The action selection engine generates an overall outcome for the overall command and sends the overall outcome to each behavior as feedback.

The control system, in some implementations, includes one or more action models, one or more behaviors, and one or more action selection engines. Each action model includes at least one action space model defining a simulated state propagation for commands for a physical resource (e.g., deck system, deck shifter, drive system, payload, etc.), a command generating routine that generates a predetermined limited number of feasible commands for the physical resource, and a command simulating routine that generates simulated outcomes using a simulated state propagation of a corresponding action space model. Each simulated outcome corresponds to one feasible command. The command generating routine may generate commands throughout the action space model, and the command simulating routine generates simulated outcomes from commands distributed throughout the action space model. Preferably, the command generating routine randomly generates commands throughout the action space model. The command generating routine may generate commands in proximity to a current command in the action space model, and the command simulating routine generates simulated outcomes from commands distributed in proximity to a current command in the action space model. The command generating routine can also randomly generate commands in proximity to a current command in the action space model. In some implementations, the command generating routine generates commands in proximity to one or more previous commands in the action space model and the command simulating routine generates simulated outcomes from commands distributed in proximity to one or more previous commands in the action space model. Preferably, the command generating routine randomly generates commands in proximity to one or more previous commands in the action space model. Each behavior includes a routine for collecting sensor data and a routine assigning scores to simulated outcomes using an evaluation routine that considers sensor data, current resource state data, and predetermined goals associated with the behavior. Each action selection engine includes a routine for sequentially obtaining simulated outcomes from each action space model, providing the simulated outcomes to each behavior object for assigning scores, weighting the scores according to a predetermined weighting among behavior objects, comparing the weighted scores to determine one winning outcome for each action space model, and then sending the one feasible command corresponding to the one winning outcome for each action space model to the physical resource corresponding to that one feasible command, one winning outcome, and one action space model.

Another aspect of the disclosure provides a mobile robot including a chassis, a drive system disposed on the chassis and configured to maneuver the robot over a work surface, a deck system, and a control system connected to the drive system and the deck system. The deck system includes a payload deck configured to receive a removable payload and a deck shifter configured to move the payload deck relative to the chassis. The control system includes a control arbitration system and a behavior system in communication with each other. The behavior system executes a deck-leveling behavior configured to evaluate and provide an outcome evaluation on a predicted outcome of a robot command. The control arbitration system selects and executes a robot command based at least in part on the outcome evaluation. The deck-leveling behavior maintains the payload deck substantially parallel to at least one of the chassis and the work surface.

In some implementations, the deck-leveling behavior determines a deck offset angle of the payload deck relative to at least one of a longitudinal axis of the chassis and the work surface. The deck-leveling behavior provides its outcome evaluation based on a difference between the deck offset angle and a threshold angle. The deck-leveling behavior may be configured to allow a user command for single axis movement of the deck system while maintaining the payload deck substantially parallel to at least one of the chassis and the work surface. For example, a user may command the deck to move forward relative to the chassis. In this case, the deck-leveling behavior causes the deck shifter of the deck system to rotate about a first axis on the chassis to move the payload deck forward relative to the chassis while also rotating the payload deck about a second axis at the payload deck to maintain the payload deck substantially parallel to the chassis and/or the work surface.

In yet another aspect of the disclosure, a mobile robot includes a chassis, a drive system disposed on the chassis and configured to maneuver the robot over a work surface, a deck system, and a control system connected to the drive system and the deck system. The deck system includes a payload deck configured to receive a removable payload and a deck shifter configured to move the payload deck relative to the chassis. The control system includes a control arbitration system and a behavior system in communication with each other. The behavior system executes a deck shifter behavior that influences execution of commands by the control arbitration system to avoid unintentional contact of the deck shifter and the payload deck with at least one of the chassis and the work surface.

In some implementations, the drive system includes a skid steer drive system disposed on the chassis and right and left driven flippers disposed on corresponding sides of the chassis. The chassis has a leading end and a trailing end, and each flipper has a pivot end and a distal end. Each flipper pivots about a first pivot axis common with a drive axis at the leading end of the chassis. The deck shifter behavior prevents movement of a leading end of the payload deck forward of the distal tips of the flippers.

The deck shifter may include a linkage having a pivot end and a distal end. The linkage pivots about a second pivot axis substantially at the leading end of the chassis. The payload deck has a mid pivot point, a leading end and a trailing end. The payload deck pivots about a third pivot axis substantially at the distal end of the linkage. The deck shifter behavior prevents collision between the linkage and the chassis.

Another aspect of the disclosure provides a mobile robot including a chassis, a drive system disposed on the chassis and configured to maneuver the robot over a work surface, a deck system, and a control system connected to the drive system and the deck system. The deck system includes a payload deck configured to receive a removable payload and a deck shifter configured to move the payload deck relative to the chassis. The control system includes a control arbitration system and a behavior system in communication with each other. The behavior system executes a stair assist behavior that coordinates movement of the drive system and the deck system executed by the control arbitration system for negotiating stairs. In some implementations, operations of the stair assist behavior include assuming a stair negotiation start pose, assuming a stair advancement pose, and maintaining a dive direction along a stair direction.

The drive system may include a skid steer drive system disposed on the chassis and right and left driven flippers disposed on corresponding sides of the chassis. The chassis has a leading end, a trailing end, and a center of gravity therebetween, and each flipper has a pivot end, a distal end, and a center of gravity therebetween. Each flipper pivots about a first pivot axis common with a drive axis at the leading end of the chassis. Assuming the stair negotiation start pose includes moving the flippers to a deployed position in front of and at an angle with respect to the chassis. Assuming the stair negotiation start pose may also include moving a center of gravity of the entire robot to a stable position. Assuming the stable position may include moving the payload deck to a parked position adjacently above the chassis, and/or moving centers of gravity of the payload deck and the deck shifter forward of the center of gravity of the chassis and rearward of the center of gravity of the flippers. Assuming the stair advancement pose may include positioning a center of gravity of the payload deck forward of the center of gravity of the chassis and above the center of gravity of the flippers. Assuming the stair advancement pose may also include positioning the center of gravity of the payload deck forward of the center of gravity of the flippers. Maintaining a dive direction may include limiting a commanded turn rate to a threshold turn rate away from the stair direction.

In some implementations, the deck shifter includes a linkage having a pivot end, a distal end, and a center of gravity therebetween. The linkage pivots about a second pivot axis substantially at the leading end of the chassis. The payload deck has a mid pivot point, a leading end and a trailing end, and a center of gravity between the two ends. The payload deck pivots about a third pivot axis substantially at the distal end of the linkage. The stair assist behavior monitors the centers of gravity of the chassis, the flippers, the linkage, the payload deck, and any received payloads to determine the center of gravity of the entire robot.

Another aspect of the disclosure provides a method of controlling a robot that includes determining an operating envelope of the robot, determining a position of a center of gravity of the entire robot with respect to the operating envelope, and and maintaining the center of gravity of the entire robot within the operating envelope. The robot includes a chassis, a drive system disposed on the chassis and configured to maneuver the robot over a work surface, a deck system. The deck system includes a payload deck configured to receive a removable payload and a deck shifter configured to move the payload deck relative to the chassis. The center of gravity of the entire robot includes at least a center of gravity of the chassis and a center of gravity of the payload deck movable with respect to the chassis.

In some implementations, the drive system includes a skid steer drive system disposed on the chassis and right and left driven flippers disposed on corresponding sides of the chassis. The chassis has a leading end, a trailing end, and its center of gravity therebetween, and each flipper has a pivot end, a distal end, and a center of gravity therebetween. Each flipper pivots about a first pivot axis common with a drive axis at the leading end of the chassis. The lateral extents between the distal ends of the flippers and the trailing ends of the skid steer drive system defines the operating envelope. The method may include preventing movement of a leading end of the payload deck forward of the distal tips of the flippers.

The deck shifter may include a linkage having a pivot end, a distal end, and a center of gravity therebetween. The linkage pivots about a second pivot axis substantially at the leading end of the chassis. The payload deck has a mid pivot point, a leading end and a trailing end, and a center of gravity between the two ends. The payload deck pivots about a third pivot axis substantially at the distal end of the linkage. The method may include monitoring the centers of gravity of the chassis, the flippers, the linkage, the payload deck, and any received payloads to determine the center of gravity of the entire robot. The method may also include preventing a collision between the linkage and the chassis.

In some implementations, the method includes maintaining the center of gravity of the entire robot inside the operating envelope when the flippers are moved, which alters the operating envelope. In other implementations, the method includes altering the operating envelope by pivoting the flippers with respect to the chassis to maintain the center of gravity of the entire robot inside the operating envelope.

The method may include determining a deck offset angle of the payload deck relative to at least one of a longitudinal axis of the chassis and the work surface and maintaining the payload deck within a threshold angle of at least one of the longitudinal axis of the chassis and the work surface.

In some implementations, the method includes running multiple applications on a processor and running periodic action selection cycles on each action selection engine. Each application has a robot controller and an action selection engine, and each application communicates with at least one behavior and at least one action model of at least part of the robot. Each action selection cycle includes selecting a command for each action space of each action model, generating a single overall command based on the accumulated commands for each action model, and sending the overall command to the robot controller for execution on the robot. The action selection cycle, in some examples, includes three phases: nomination, action selection search, and completion. In the nomination phase, each action model and each behavior are informed of the system state and of the start of the action selection cycle. In the action selection search phase, the action selection engine generates feasible commands and corresponding outcomes from the action spaces (space of available actions) in each action model. The action selection engine will make multiple calls to evaluation functions searching for the best possible outcome in the time available for the cycle. The action models generate the feasible commands and corresponding future outcomes that are evaluated by the behaviors. The action selection engine accumulates the outcome evaluations by the behaviors for every action space and selects the best outcome and corresponding command for each action space. The action selection engine generates an overall command based on the accumulated commands for each action space as well as a simulated overall outcome corresponding to the overall command. In the completion phase, the action selection engine sends the overall command to the connect robot controller for execution and sends the overall outcome to all active behaviors and behavior primitives as feedback on the cycle (allowing primitives to adapt, if possible).

In some implementations, the action selection cycle includes obtaining a system state from the robot controller, informing each action model and each behavior of the system state, and informing each action model and each behavior of the start of the action selection cycle. Selecting a command for each action space, in some examples, includes calling the corresponding action model to generate feasible commands for the action space, calling the corresponding action model to generate outcomes for the feasible commands, calling each behavior to evaluate and provide an outcome evaluation for each outcome, accumulating the outcome evaluations of each behavior, selecting a winning outcome for the action space, and selecting the command corresponding to the winning outcome. The method may include implementing an application priority policy that determines which application has exclusive control of resources of the robot required by that application at a given time. The application priority policy may be implemented by a robot manager in communication with each robot controller.

In yet another aspect of the disclosure, a method of controlling a robot to negotiate steps includes assuming a stair negotiation start pose, assuming a stair advancement pose by positioning a center of gravity of a payload deck forward of the center of gravity of the chassis and above the center of gravity of the flippers; and maintaining a dive direction along a stair direction. The stair negotiation start pose is assumed by moving right and left driven flippers disposed on corresponding sides of a chassis of the robot to a deployed position and moving a center of gravity of the entire robot to a stable position. Each flipper has a pivot end, a distal end, and a center of gravity therebetween, and each flipper pivots about a first pivot axis common with a drive axis at the leading end of the chassis. The chassis has a leading end, a trailing end, and a center of gravity therebetween. The deployed flippers are positioned in front of and at an angle with respect to the chassis.

Assuming the stable position may include moving the payload deck to a parked position adjacently above the chassis. Assuming the stable position may also include moving centers of gravity of the payload deck and the deck shifter forward of the center of gravity of the chassis and rearward of the center of gravity of the flippers. Assuming the stair advancement pose may be achieved, at least in part, by positioning the center of gravity of the payload deck forward of the center of gravity of the flippers. Maintaining a dive direction may include limiting a commanded turn rate to a threshold turn rate away from the stair direction.

The details of one or more implementations of the disclosure are set forth in the accompanying drawings and the description below. Other aspects, features, and advantages will be apparent from the description and drawings, and from the claims.

### DESCRIPTION OF DRAWINGS

FIG. 1 is a perspective view of an exemplary robotic vehicle.

FIG. 2 is an exploded view of the robotic vehicle shown in FIG. 1.

FIG. 3 is a front view of the robotic vehicle shown in FIG. 1.

FIG. 4 is a back view of the robotic vehicle shown in FIG. 1.

FIG. 5 is a top view of the robotic vehicle shown in FIG. 1.

FIG. 6 is a bottom view of the robotic vehicle shown in FIG. 1.

FIG. 7 is an exploded perspective view of the robotic vehicle shown in FIG. 1.

FIG. 8 is a side view of the robotic vehicle shown in FIG. 1.

FIG. 9 is an side view of the robotic vehicle shown in FIG. 1 and identifying centers of gravity of various portions of the robotic vehicle.

FIG. 10 is a perspective view of a robotic vehicle with a manipulator arm.

FIG. 11 is a perspective view of a robotic vehicle in a neutral posture and illustrating an exemplary operating envelope.

FIG. 12 is a perspective view of a robotic vehicle in a standing posture and illustrating an exemplary operating envelope.

FIG. 13 is a perspective view of a robotic vehicle in a kneeling posture.

FIG. 14 is a perspective view of a robotic vehicle in a kneeling posture.

FIG. 15A is a schematic view of a robotic vehicle and control system.

FIG. 15B provides a flowchart of an exemplary arrangement of operations of a peak power load balancing module.

FIG. 15C is a schematic view of a robotics control system.

FIG. 16 is a schematic view of a control arbitration system.

FIG. 17 is a schematic view of a behavior system.

FIG. 18 is a schematic view of an action selection cycle.

FIG. 19 provides a flowchart of an exemplary arrangement of operations of an anti-tip behavior.

FIG. 20 provides a flowchart of an exemplary arrangement of operations of the deck leveling behavior.

FIG. 21 provides a flowchart of an exemplary arrangement of operations of the stair assist behavior.

FIGS. 22-25 are side views of a robotic vehicle climbing.

FIGS. 26-29 are side views of a robotic vehicle with a received payload climbing.

FIG. 30 provides a flowchart of an exemplary arrangement of operations of the payload manager behavior.

FIGS. 31-36 provides exemplary charts of rotate and translate commands converted to modified and unmodified right and left drive motor commands.

Like reference symbols in the various drawings indicate like elements.

### DETAILED DESCRIPTION

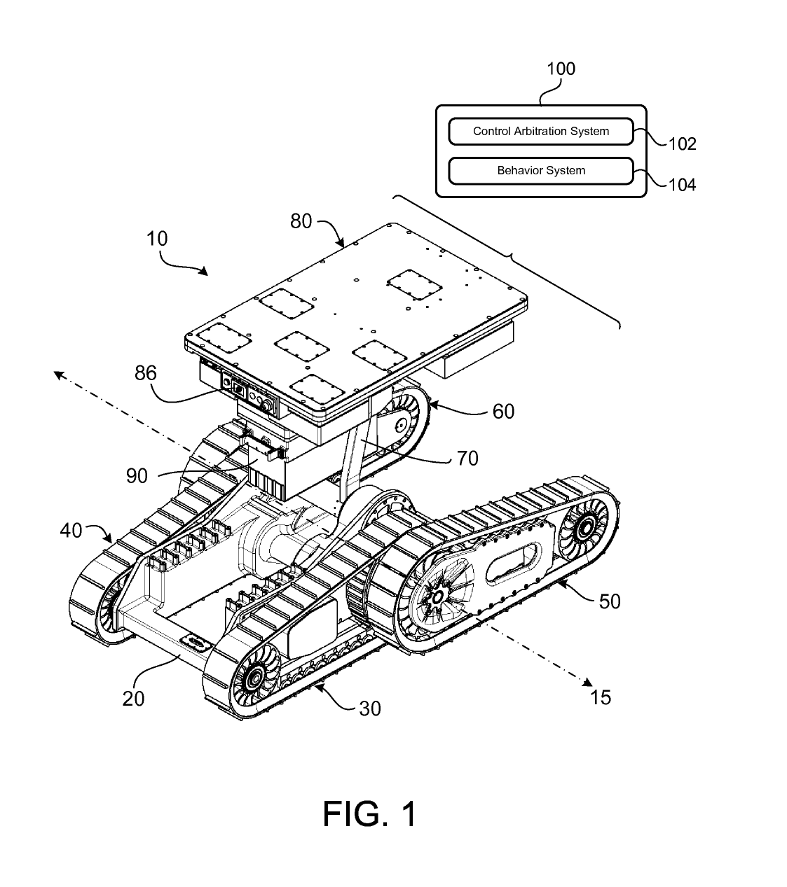

Referring to FIG. 1, in some implementations, a robotic vehicle 10 (also referred to as a mobile robot) is remotely operated to perform manpower intensive or high-risk functions (i.e., explosive ordnance disposal; urban intelligence, surveillance, and reconnaissance (ISR) missions; minefield and obstacle reduction; chemical/toxic industrial chemicals (TIC)/toxic industrial materials (TIM); etc.) without exposing operators directly to a hazard. These functions often require the robotic vehicle 10 to drive quickly out to a location, perform a task, and either return quickly or tow something back. The robotic vehicle 10 is operable from a stationary position, on the move, and in various environments and conditions.

Referring to FIGS. 1-6, the robotic vehicle 10 includes a chassis 20 that is supported on right and left drive track assemblies 30, 40 having corresponding driven tracks 34, 44. Each driven track 34, 44 is trained about a corresponding front wheel 32, 42, which rotates about front wheel axis 15. Right and left flippers 50, 60 are disposed on corresponding sides of the chassis 20 and are operable to pivot about the front wheel axis 15 of the chassis 20. Each flipper 50, 60 has a corresponding driven track 54, 64 about its perimeter that is trained about a corresponding rear wheel 52, 62, which rotates about the front wheel axis 15.

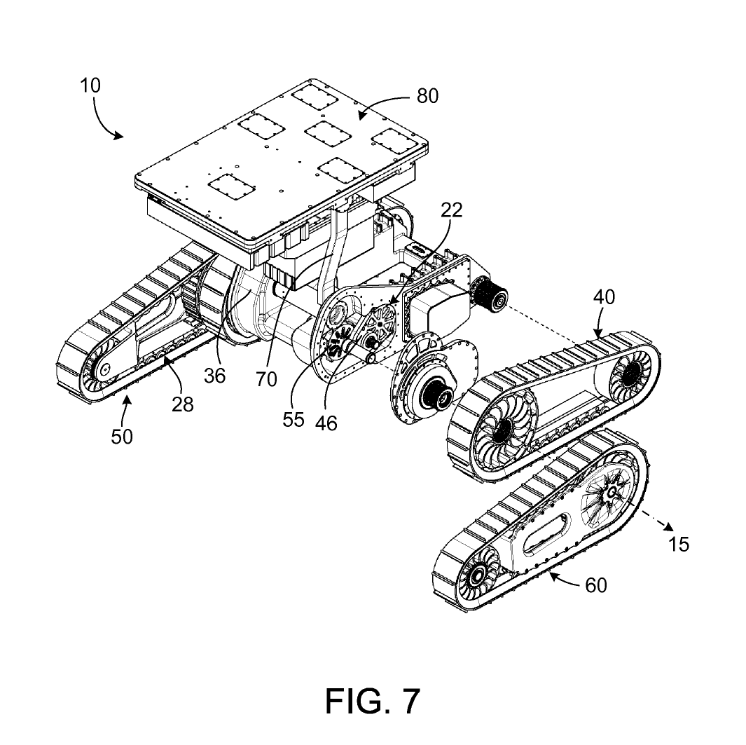

Referring to FIG. 7, in one implementation, the robotic vehicle 10 includes right and left motor drivers 36, 46 driving corresponding drive tracks 34, 44 and flipper tracks 54, 64, which are supported between their front and rear ends by bogie wheels 28. A flipper actuator module 55 is supported by the chassis 20 and is operable to rotate the flippers 50, 60. In some examples, the flippers 50, 60 are actuated in unison, while in other examples, the flippers 50, 60 are actuated independently by right and left flipper actuators 55.

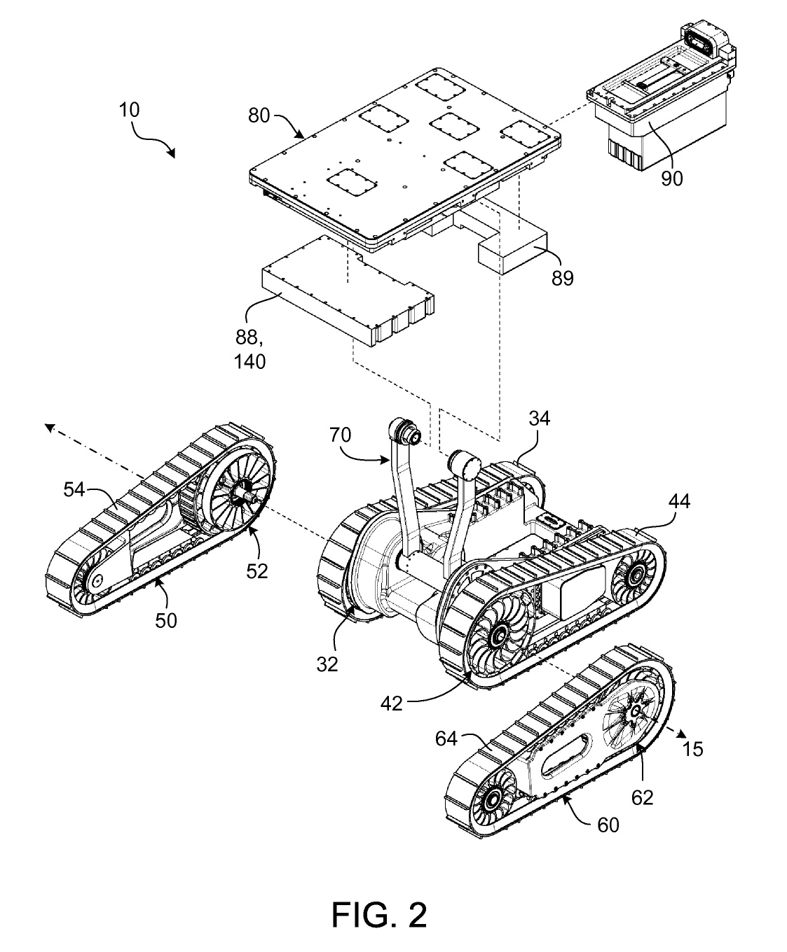

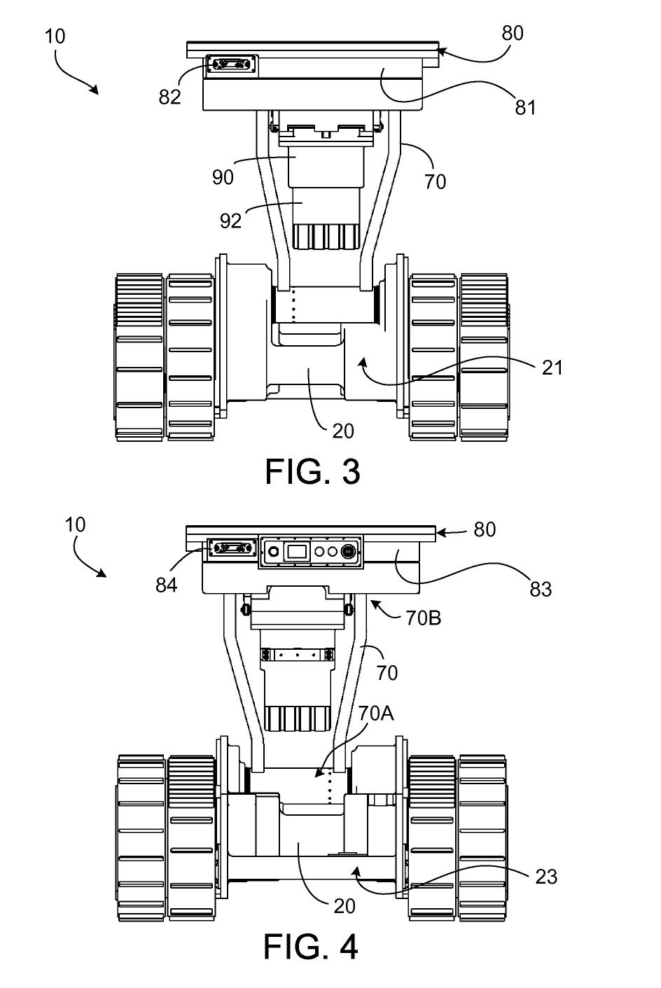

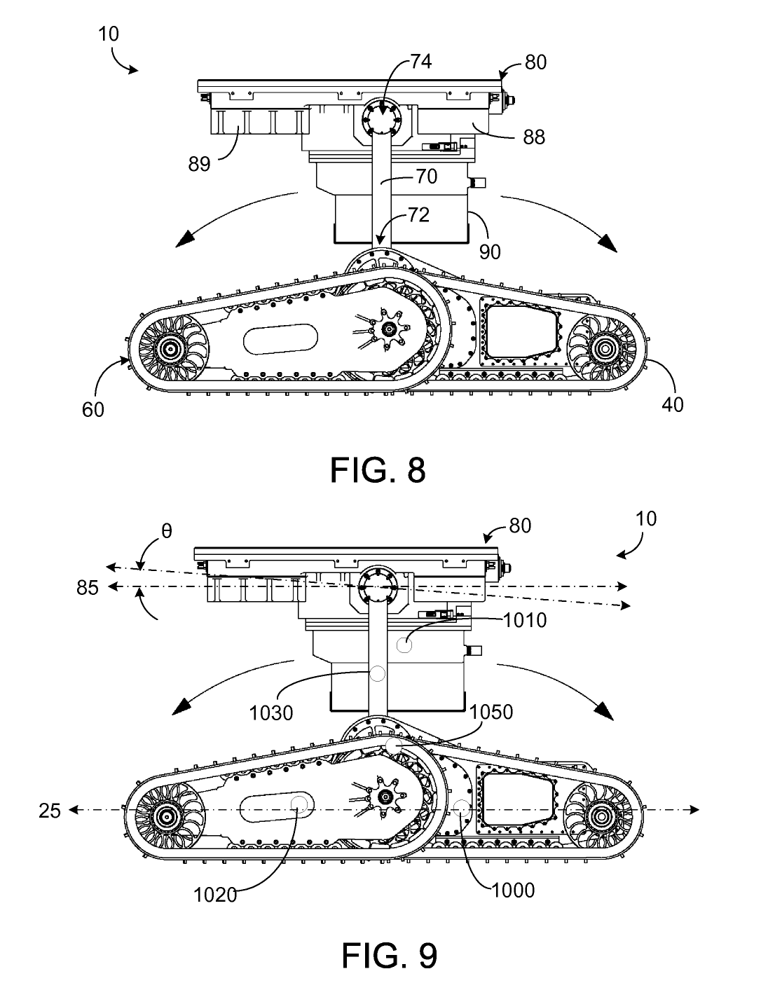

Referring to FIG. 8, a deck shifter 70 connects a payload deck assembly 80 to the chassis 20. The deck shifter 70 is also referred to as a center of gravity (CG) shifter and, as in the example shown, may be implemented as a linkage 70. The linkage 70 has a first end 70A rotatably connected to the chassis 20 at a first pivot 71, and a second end 70B rotatably connected to the payload deck 80 at a second pivot 73. Both of the first and second pivots 71, 73 include respective independently controllable pivot drivers 72, 74 operable to rotatably position their corresponding pivots to control both fore-aft position and pitch orientation of the payload deck assembly 80 with respect to the chassis 20. The payload deck assembly 80 has forward and rearward faces 81, 83 (FIGS. 3 and 4). As shown in FIGS. 1-2, the linkage 70 may comprise two parallel links spaced apart laterally or a single unitary link (not shown). The deck assembly 80 includes one or more connection points or pads 810 for providing both a payload power link and a payload communication link. The payload connection pads 810 may be positioned to accommodate selective connection of multiple payloads 500 to the payload deck assembly 80.

Referring to FIG. 9, the first end 70A of the linkage 70 is rotatably connected near the front of the chassis 20 such that the payload deck assembly 80 is displaceable to an aftmost position in which the payload deck assembly 80 is located within a footprint of the chassis 20. Furthermore, as shown in FIGS. 1-2, the first pivot 71 of the linkage 70 is located above and forward of the front wheel axis 15. The first pivot 71 is rotatable through an angle of at least 180 degrees (optionally, 74 degrees), in some examples. Rotation of the linkage 70 about its first and second pivots 71, 73 enables selective positioning of center of gravity 1010 of payload deck assembly 80 both fore and aft front wheel axis 15 as well as both fore and aft a center of gravity 1000 of the chassis 20. In additional examples, the independently controllable pivot drivers 72, 74 provide both fore-aft position (as part of sweep) and pitch orientation of the payload deck assembly 80 with respect to the chassis 20 to selectively displace the center of gravity 1010 of the payload deck assembly 80 both forward and rearward of the center of gravity 1000 of the chassis 20, displacing a center of gravity 1050 of the entire robot 10.

The robotic vehicle 10 may sense elements of balance through the linkage 70 (e.g., via motor load(s), strain gauges, and piezoelectric sensors), allowing an operator or autonomous dynamic balancing routines to control the center of gravity 1010 of the payload deck assembly 80 and the center of gravity 1030 of the linkage 70 for enhanced mobility, such as to avoid tip over while traversing difficult terrain.

A straight shaft may join both flippers 50, 60 directly, allowing the bottom pivoting actuator 72 to be placed off center with the flipper actuator 55. Additional pivot range past 180 degrees may be obtained, as with additional standing height, by increasing the distance between the first pivot 71 and the common chassis-flipper axis 15.

If positioned concentrically with the front wheel axis 15 (also known as the flipper-chassis joining axis), the linkage rotation range could be 360 degrees. Other constraints designed herein and other advantages obtainable in other positions can change this. For example, if the first pivot 71 of the linkage 70 is positioned above and forward of the common chassis-flipper axis 15 (e.g., about 20 mm forward and about 70 mm above), it is possible to have a unitary structure for the chassis 20 (casting). Other systems may have a range of considerably less than 180 degrees, for example if the parts of such systems are limited in a pivoting or movement range by interference among the system members. Still further, a two bar linkage has a longer effective forward extending range, since the linkage 70 is substantially stowable to the chassis 20. The distance between more than one chassis connections of the other systems may shorten the effective forward extending range. As one additional advantage, a deck-side actuator 74 of the two-bar linkage 70 can be used to “nod” (auxiliary scan) a scanning (main scanning) sensor such as a 2D LADAR or LIDAR to give a 3D depth map.

The robotic vehicle 10 is electrically powered (e.g. a bank of nine standard military BB-2590 replaceable and rechargeable lithium-ion batteries). Referring to FIGS. 2-3, in some implementations, the payload deck assembly 80, specifically the electronics tub 90, accommodates a slidable, removable battery unit 92. Skid pad 94, as shown in FIG. 6, may be secured to the bottom of the battery unit 92 to protect the battery 92 and aid manageability. The payload deck assembly 80 may carry an additional battery supply on one of the selectable connection pads 810, increasing the available power capacity (e.g. an additional bank of nine batteries may be carried on payload deck). In some implementations, a removable battery unit 92 is carried by the chassis 20 in addition to or instead of the payload deck assembly 80.

Referring again to FIGS. 2-6, the payload deck assembly 80, in some implementations, includes an electronics bin 90 and a payload deck 806, which is configured to support a removable functional payload 500. FIGS. 3-4 illustrate the robotic vehicle 10 with the payload deck assembly 80 including front and rear functional payload power connectors, 82 and 84, and a user interface panel 86. FIG. 2 illustrates an example where the payload deck assembly 80 includes front and rear sensor pods, 88 and 89 respectively. In some implementations, the sensor pods 88, 89 provide infrared, chemical, toxic, light, noise, and weapons detection, as well as other types of sensors and detection systems. A primary driving sensor may be housed in a separate audio/camera sensor module mounted to the payload deck assembly 80 that contains at least one visible spectrum camera. Audio detection and generation is realized using an audio/camera sensor module mounted to the payload deck assembly 80, in one example. Other sensors include inertia measurement units, accelerometers, and gyroscopes for determining the location and orientation (e.g., angular position) of various components, such as the payload deck assembly 80 and/or payload 500 with respect to the chassis 20.

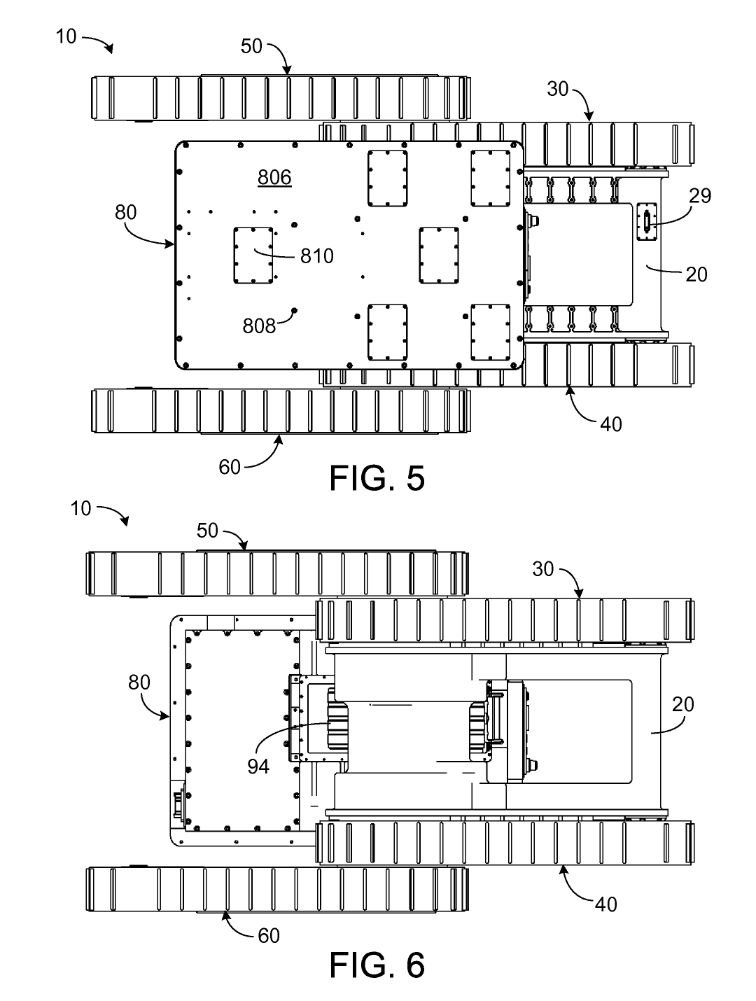

In some implementations, robotic vehicle 10 tows a trailer connected to rear payload connector 29, as shown in FIG. 5. Exemplary payloads for the trailer include a small generator, which significantly extends both range and mission duration of robotic vehicle, field equipment, and additional functional payload units 500 attachable to the payload deck assembly 80.

The payload deck assembly 80 accepts the mounting of one or more functional payload modules 500 that may include robotic arms, chemical, biological and radiation detectors, and a sample container. The robotic vehicle 10 automatically detects the presence and type of an installed functional payload 500 upon start-up. Referring to FIG. 5, the payload deck 806 defines threaded holes 808 to accept a functional payload 500. FIG. 5 also illustrates one or more functional payload connection pads 810 positioned on the payload deck assembly 80 to accommodate selective connection of multiple functional payload units 500. Each functional payload connection pad 810 delivers power, ground and communications to a functional payload unit 500. For example, robotic vehicle 10 may provide up to 300 W (threshold), 500 W (goal) of power to a payload 500 at 42V, up to 18 A. The communication link may include Ethernet link communications. Details on communicating with a peripheral device over a network as well other details and features combinable with those described herein may be found in U.S. patent application Ser. No. 11/748,363, filed May 14, 2007, the entire contents of which are hereby incorporated by reference. In some examples, the payload deck assembly 80 constitutes between about 30 and 70 percent of the vehicle's total weight. The payload deck assembly 80 may include a removable controller unit 140 operably connected to a drive system (e.g. the motor drivers 36, 46) of the chassis 20. In some examples, the controller unit 140 is carried by the chassis 20. The robotic vehicle 10 communicates with an operator control unit (OCU) through optional communication functional payload module(s) 500. The robotic vehicle 10 is capable of accepting and communicating with a radio functional payload module 500.

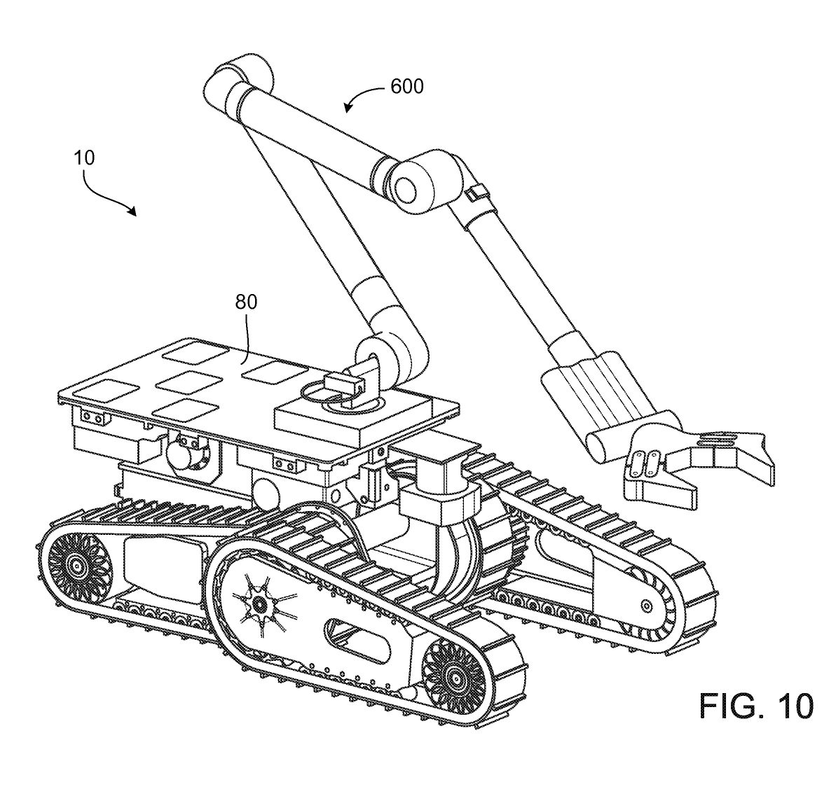

FIG. 10 illustrates a robotic arm module 600 as a functional payload 500 attached to the payload deck assembly 80. The robotic arm module 600 provides full hemispherical reach (or more, limited only by interference; or less, limited by other needs of the robot 10) around the robotic vehicle 10. The robotic arm module 600 provides lifting capacity and an additional means for shifting the robotic vehicle's center of gravity 1050 forward, e.g. when ascending steep inclines, and rearward, e.g. for additional traction.

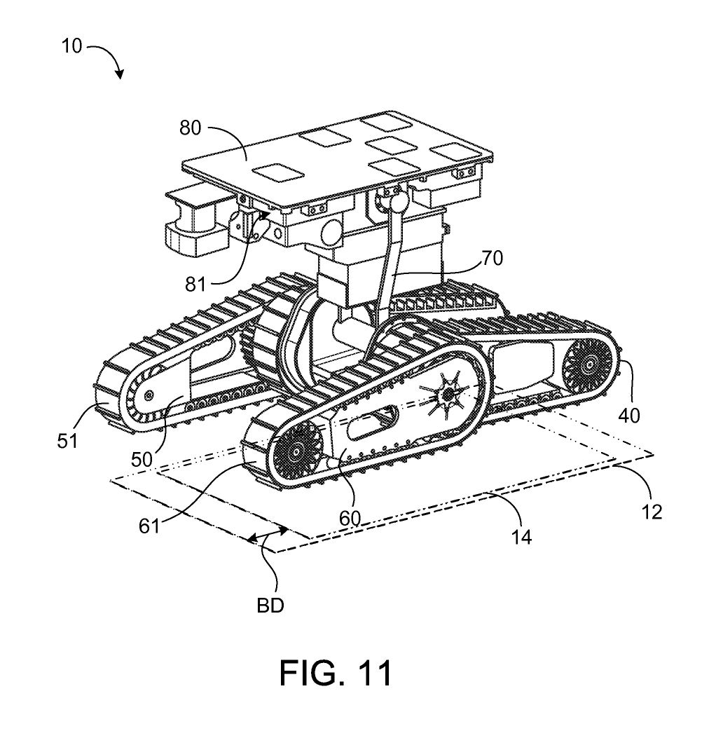

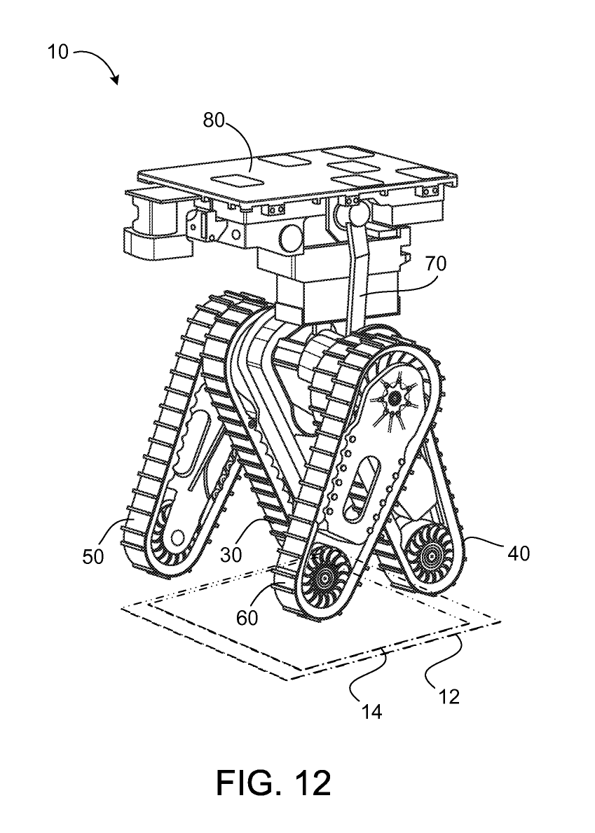

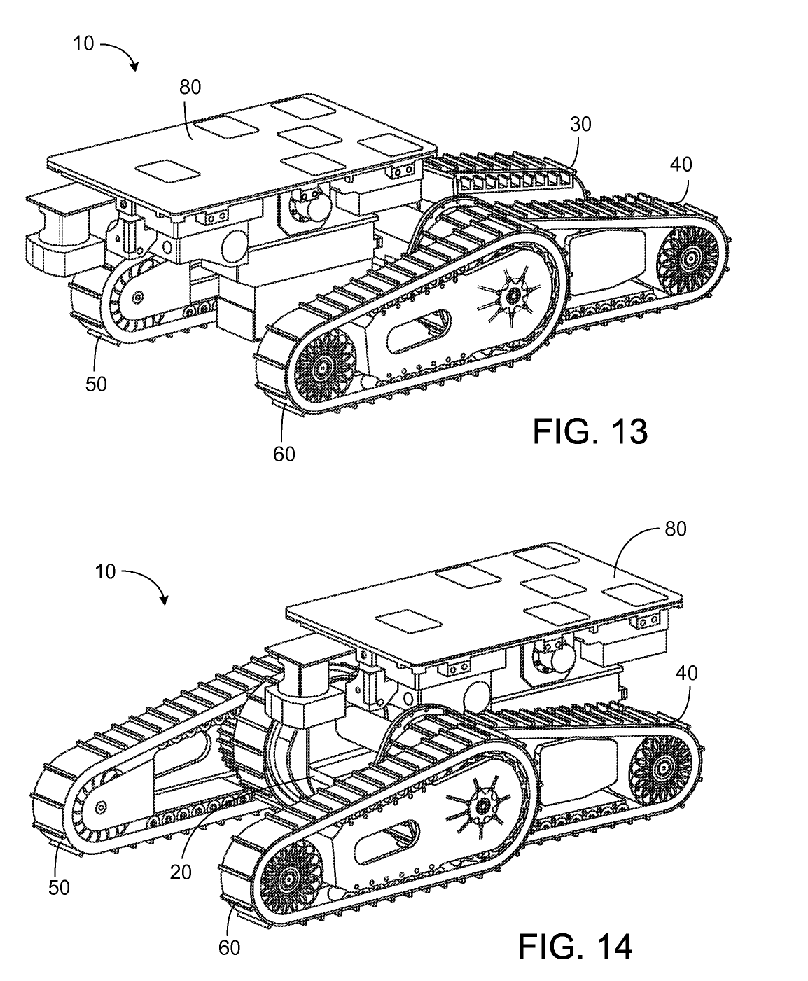

Referring to FIGS. 11-14, the robotic vehicle 10 may exhibit a variety of postures or poses to perform tasks and negotiate obstacles. The linkage 70 together with the deck assembly 80, chassis 20, and flippers 50, 60 all move to attain a number of standing postures. FIG. 11 depicts robotic vehicle 10 in a neutral posture. FIG. 12 depicts the robotic vehicle 10 in one standing posture wherein the distal end of flippers 50 and 60 approaches the leading end of the chassis 20 to form an acute angle between the flippers 50 and 60 and the chassis 20. The linkage 70 is entirely above a common axis 15 of the flippers 50 and 60 and the chassis 20. In one example, the deck assembly 80 tilts independently with respect to the robotic vehicle 10. The acute angle achieved between the flippers 50 and 60 and the chassis 20 varies the standing positions without changing the orientation of the deck assembly 80 with respect to the ground. In some examples, the linkage 70 is positionable at least parallel to an imaginary line between the distal and pivot ends of flippers 50 and 60. In additional examples, the second end 70B of the linkage 70 is positionable below an imaginary line between the distal and pivot ends of flippers 50 and 60. In another implementation, the linkage 70 together with the deck assembly 80, chassis 20, and flippers 50 and 60 can move to attain a first kneeling position, as shown in FIG. 13, and a second kneeling position, as shown in FIG. 14. The second kneeling position is also a position in which the deck assembly 80 is in a parked position.

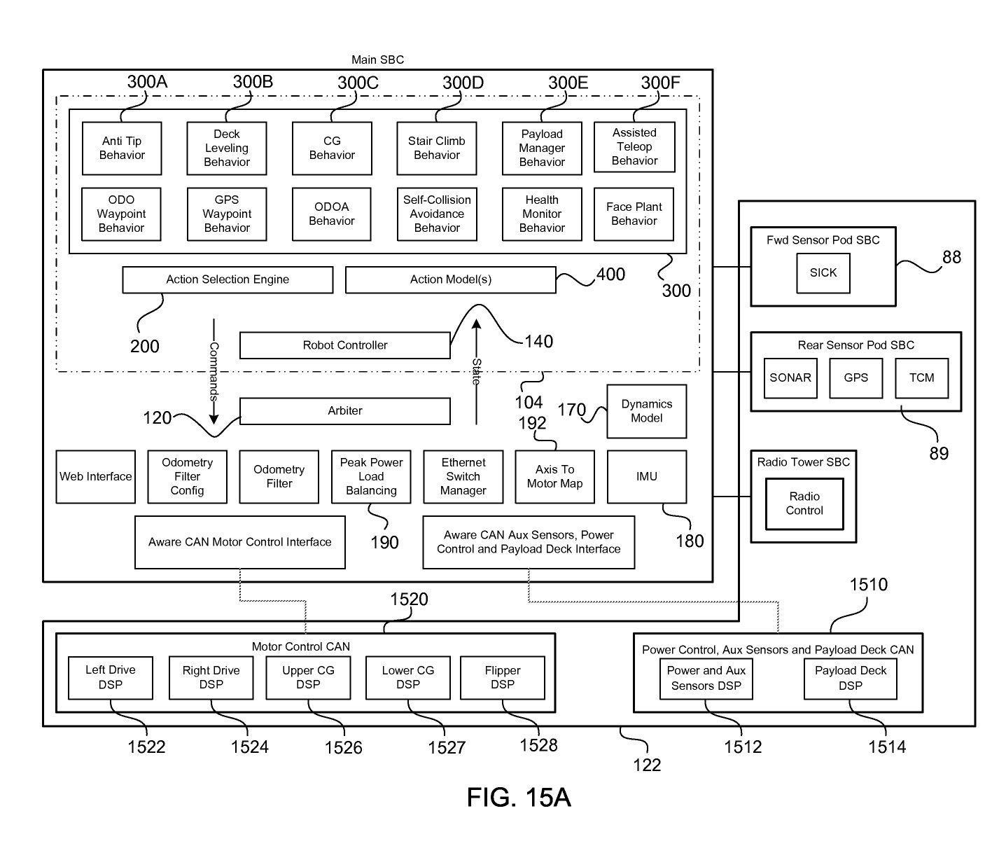

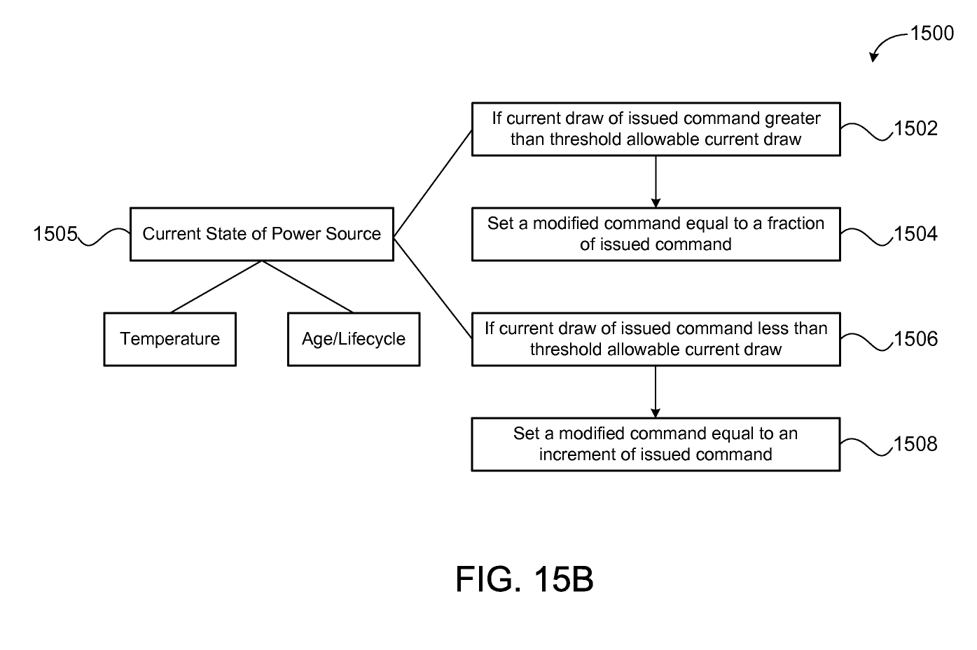

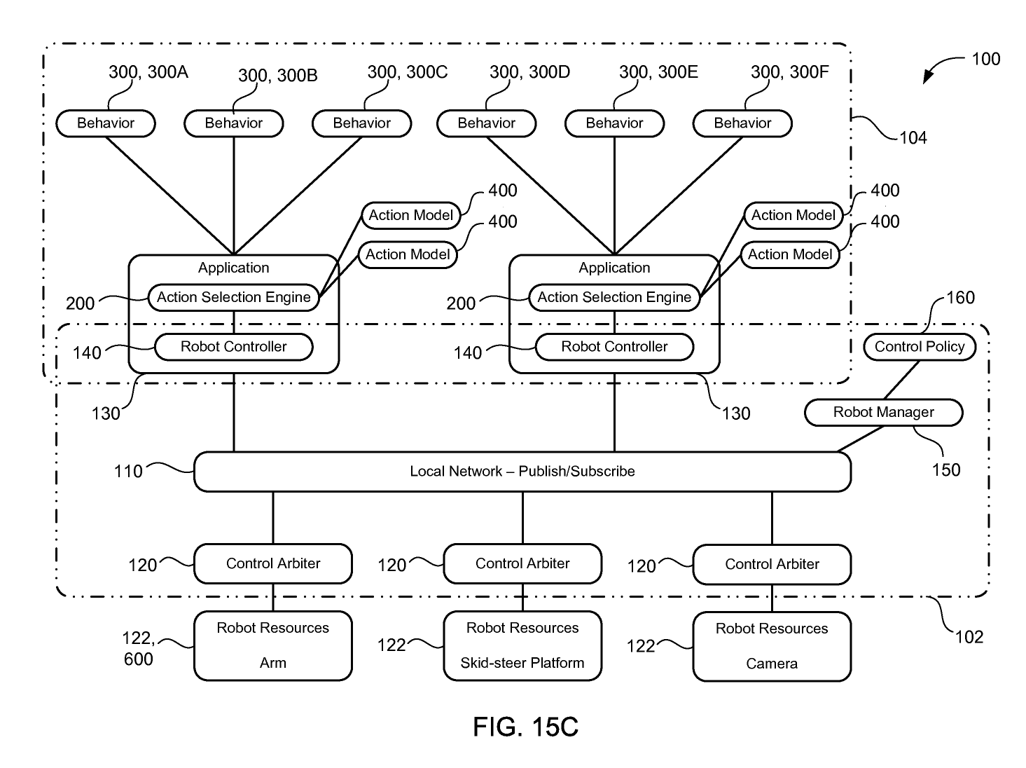

Referring to FIGS. 1 and 15A-15C, a robotics system 100 (also referred to herein as a control system) allows separately written and independently deployed programs or applications 130, stored in memory of or communicated to the robot 10, to run concurrently on (e.g., on a processor) and simultaneously control a robot 10. The independently deployed applications 130 are combined dynamically at runtime and need to be able to share resources of the robot 10. A low-level policy is implemented for dynamically sharing the robot resources among the applications at run-time. The policy determines which application 130 has control of the robot resources 122 required by that application 130 (e.g. a priority hierarchy among the applications). Applications 130 can start and stop dynamically and run completely independently of each other. The robotics system 100 also allows for complex behaviors 300 which can be combined together to assist each other. The robotics system 100 includes a control arbitration system 102 and a behavior system 104 in communication with each other. The control arbitration system 102 allows applications 130 to be dynamically added and removed from the robotics system 100, and facilitates allowing applications 130 to each control the robot without needing to know about any other applications 130. In other words, the control arbitration system 102 provides a simple prioritized control mechanism between applications 130 and the resources 122 of the robotics system 100. The control arbitration system includes one or more robot controllers 140, a robot manager 150, and one or more control arbiters 120. These components do not need to be in a common process or computer, and do not need to be started in any particular order. This capability allows for different modules (e.g. payloads 500) with self contained computing power to be plugged into the robotics systems 100, as well as the ability to plug in a small piece of robot brain providing different capabilities to the overall robotics system 100, while using the same actuator space.

The robot controller 140 component provides an interface to the control arbitration system 102 for applications 130. There is an instance of this component for every application 130. The robot controller 140 abstracts and encapsulates away the complexities of authentication, distributed resource control arbiters, command buffering, and the like. In the example shown in FIG. 15A, the robot controller 140 communicates over a power—auxiliary sensors—payload deck CAN bus 1510 to a power and auxiliary sensors signal processor 1512 (preferably a digital signal processor (DSP)) and a payload deck signal processor 1514 (preferably a digital signal processor (DSP)). The power and auxiliary sensors signal processor 1512 monitors any auxiliary sensors as well as the power source type, temperature, and available power level for each power source 90 connected to the signal processor 1512. The payload deck signal processor 1514 monitors the power source type, temperature, and available power level for each power source 90 connected to the payload deck 80. When multiple power sources 90 are installed on the robotic vehicle 10 (i.e. on the chassis 20 and/or the payload deck 80), power management control logic detects via the auxiliary sensors signal processor 1512 and the payload deck signal processor 1514 the power source type, temperature, and available power level for each power source 90. The auxiliary sensors signal processor 1512 and the payload deck signal processor 1514 each control recharging of an associated power source 90 based on power source type, temperature, and available power level for each power source 90. The robot controller 140 may also communicate with right and left drive modules 1522,1524, CG shifting actuator modules 1526, 1527 (for the linkage 70), and a flipper drive module 1528 over a motor control controller area network (CAN) bus 1520 to control these modules and/or receive sensor data, such as angular position data (e.g., from absolute encoders).

A peak power load balancing module 190 may be implemented to remedy problems caused by using conventional lithium-ion batteries as the power source 90, particularly the military standard lithium-ion batteries of 2009 (e.g., BB-2590, cobalt chemistry based). These batteries are generally a common inexpensive depot item as the state of the art high energy density solution for common electronics. A robotic vehicle 10 weighing about 100 kg or more and using lithium-ion batteries (e.g., military BB-2590 batteries) as a power source 90 may experience situations where the power source 90 cannot supply enough power (or current) to meet the demands of the robotic vehicle 10, such as while driving and turning at relatively high speeds. For example, the BB-2590 lithium ion battery may only discharge a maximum of 10 amperes. The power source 90 may experience high discharge rates for the robotic vehicle 10 to carry one or a series of commands. Sometimes these high discharge rates of the power source 90 are a function of the chemistry of the type of power source 90 used. For example, a power source 90 having a lithium iron phosphate cathode material may experience relatively lower rates of discharge than one having a lithium cobalt oxide cathode material. The peak power load balancing module 190 may be implemented to accommodate for the power supplying ability of the type of power source 90 used by the robotic vehicle 10. The peak power load balancing module 190, in general, determines the power demands of commands to the robotic vehicle 10 and modifies the commands, if necessary, to draw power less than and/or equal to a maximum amount of power available by the power source 90 at any given time.

The peak power load balancing module 190 is implemented at a lower level than the behaviors 300, as it executes at a higher rate, and interacts with the arbiter 120. When the arbiter 120 issues a command to robot resources 122, the peak power load balancing module 190 determines an amount of power (or current) that will be drawn from the power source 90 (e.g., one or more lithium-ion batteries), determines if the command requires more power (or current) than available by the power source 90, and modifies the issued command, if necessary, to stay within the power supply capabilities of the power source 90 (e.g., to not under-volt the robotic vehicle 10). The peak power load balancing module 190 may be used for movement commands to the drive motors 36, 46 and/or other actuators, such as the flipper actuator 55, linkage pivot drivers 72, 74, and a movable payload, such as a manipulator arm 600. For commands that include general velocity commands, the peak power load balancing module 190 may have a differential effect. For example, a drive command issued equally to both drive motors 36, 46 may be modified by the peak power load balancing module 190 such that the modified command results in more power (or current) being delivered to one drive motor 36, 46 over the other (e.g., to accommodate traction differences, turning, etc.).

In some implementations, the peak power load balancing module 190 implements a set of operations or rules illustrated in the flowchart 1500 shown in FIG. 15B. If 1502 the command issued by the arbiter 120 requires a current draw from the power source 90 that is greater than a threshold allowable current draw of the power source 90, then set 1504 a modified command to equal a fraction of the issued command. For example, if the arbiter 120 issues a command to drive at a certain speed and the drive motors 36, 46 require a current draw from the power source 90 that exceeds the threshold allowable current draw of the power source 90, then the peak power load balancing module 190 modifies the issued command to stay within the threshold allowable current draw of the power source 90 by reducing the commanded speed to a fraction of the issued speed. If 1506 the command issued by the arbiter 120 requires a current draw from the power source 90 that is less than a threshold allowable current draw of the power source 90, then set 1508 a modified command to equal an increment of the issued command. For example, if the arbiter 120 issues a command to drive at a certain speed and the drive motors 36, 46 require a current draw from the power source 90 that is less than the threshold allowable current draw of the power source 90, then the peak power load balancing module 190 modifies the issued command to be closer to the threshold allowable current draw of the power source 90 by incrementing the commanded speed higher. This allows for a relatively slow increase in maximum allowable speed though a gentle limit cycle.

The peak power load balancing module 190, in some implementations, determines the threshold allowable current draw of the power source 90 based on a current state 1505 of the power source 90. The current state 1505 of the power source 90 may depend on the temperature of the power source 90 and its age, as determined by the number of charge cycles (lifecycle) of the power source 90 (e.g., one or more lithium-ion batteries). If the current state 1505 of the power source 90 is such that the power source is low and/or near its end of life, the peak power load balancing module 190 may set the threshold allowable current draw of the power source 90 to a fraction of the actual threshold allowable current draw, so as to operate the robotic vehicle 10 in a lower power mode (e.g., to signal to an operator that the power source 90 is near depletion and/or to conserve remaining power for the robot controllers 140).

The robot manager 150 coordinates the prioritization of applications 130, by controlling which application 130 has exclusive control of any of the robot resources 122 at any particular time. Since this is the central coordinator of information, there is only one instance of the robot manager 150 per robot. The robot manager 150 implements a priority policy 260, which has a linear prioritized order of the robot controllers 140, and keeps track of the resource control arbiters 120 that provide hardware control.

The control arbiter 120 receives the commands from every application 130 and generates a single command based on the applications' priorities and publishes it for its associated resources 122. The control arbiter 120 also receives state feedback from its associated resources 122 and sends it back up to the applications 130. Robot resources 122 may be a network of functional modules (e.g. actuators, drive systems, and groups thereof) with one or more hardware controllers. Each resource 122 has a control arbiter 120 that issues commands to that resource 122. The robot resources 122 are pluggable and may be dynamically added or removed from the robot system 100 and its network 110 at run-time. The commands of the control arbiter 120 are specific to its resource 122 to carry out specific actions.

A dynamics model 170 executable on the controller unit 140 is configured to compute the center for gravity (CG), moments of inertia, and cross products of inertial of various portions of the robot for the assessing a current vehicle state. The dynamics model 170 may be configured to calculate the center of gravity 1000 of the chassis 20, the center of gravity 1010 of payload deck assembly 80, the center of gravity 1020 of the flippers 50, 60, the center of gravity 1030 of the linkage 70, and/or the center of gravity 1050 of the entire robot 10 (shown in FIG. 9). In some implementations, the dynamics model 170 monitors and calculates the robot's associated CGs 1000, 1010, 1020, 1030, 1050 by communicating with position encoders (e.g., absolute (angular position) encoders) disposed at joints between the respective components, such as between the chassis 20 and the linkage 70, between the linkage 70 and the payload deck assembly 80, and between the flippers 50, 60 and the chassis 20. The dynamics model 170 may also model the shapes, weight, and/or moments of inertia of these components, as well as any payload 500 on the payload deck assembly 80. In some examples, the chassis 20 includes an inertial moment unit (IMU) or portions of one (e.g., accelerometers and/or gyros) in communication with the controller 140 for calculating the CGs 1000, 1010, 1020, 1030, 1050 of the robot 10. For example, three orthogonal accelerometers may be used to determine a direction of gravity (as well as other accelerations). Other robot components, such as the linkage 70, the payload deck assembly 80, and the flippers 50, 60 may have an inertial moment unit 180 (IMU) or portions of one (e.g., accelerometers and/or gyros) in communication with the controller 140 as well. The dynamics model 170 may communicate via the controller 140 with the with right and left drive modules 1522,1524 and CG shifting actuator modules 1526, 1527, and a flipper drive module 1528 over a motor control controller area network (CAN) bus 1520 to determine motor loads a virtual sensors, which may be used in calculating changes in center of gravities and rates of change in movement of the overall center of gravity 1050. The dynamics model 170 can be used by the controller 140, along with other programs 130 or behaviors 300 to determine operating envelopes of the robot 10 and its components.

Referring to FIG. 15C, the robotics system 100 for a robot 10 includes a network 110 that provides intra-process communication for the control arbitration system 102 via a real-time publish/subscribe system. Publish/subscribe (or pub/sub) is an asynchronous messaging paradigm where senders (publishers) of messages are not programmed to send their messages to specific receivers (subscribers). Rather, published messages are characterized into classes, without knowledge of what (if any) subscribers there may be. Subscribers express interest in one or more classes, and only receive messages that are of interest, without knowledge of what (if any) publishers there are. This decoupling of publishers and subscribers can allow for greater scalability and a more dynamic network topology. A publication provides a mechanism for updating a specific data item in a distributed database, so that the value will be propagated to all interested parties (the “subscribers”) without the publication client having any knowledge of subscribers. A subscription provides a mechanism for accessing a specific data item from a distributed database, without knowledge of the exact source of that data item (the “publisher”). For example, behaviors 300 can collect sensor information published to the publish/subscribe system on the local network 110. In another example, the robot controllers 140 can publish commands 440 to shared memory of the pub/sub system on the local network 110 that is accessed by control arbiters 120 to pull the commands 440 in any particular order. Preferably, the control arbiters 120 pull the commands 440 according to a published priority policy 160.

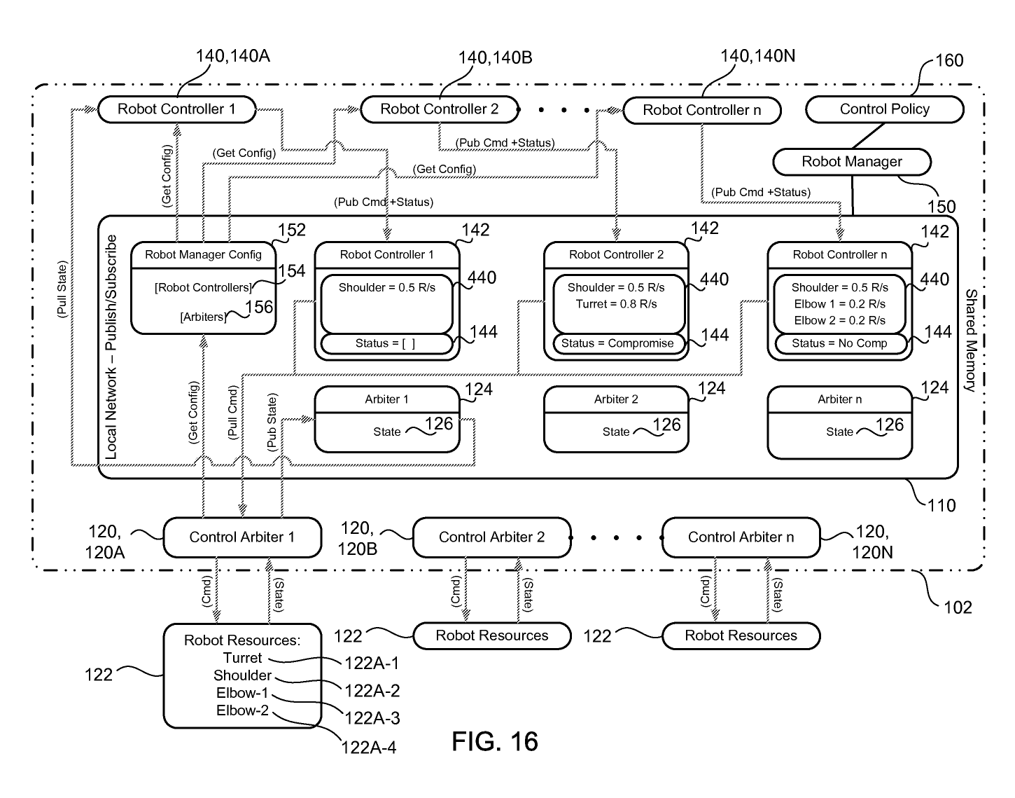

FIG. 16 provides an example of a control arbitration process on the control arbitration system 102. The robot manager 150 has a robot manager configuration 152 stored in shared memory (e.g. for the pub/sub system) of the local network 110 that implements the control policy 160. The robot manager configuration 152 stores a user defined robot controller list 154 of all the robot controllers 140 (e.g. by name) and a user defined control arbiter list 156 of all the control arbiters 120 (e.g. by name) available within the robotics system 100. The robot controller list 154 and the control arbiter list 156 may be ordered by a user or automatically by a system process to provide a linear prioritization of the robot controllers 140 and the arbiters 120. Every robot controller 140 itemized in the robot controller list 154 has a corresponding robot controller memory block 142 in the shared memory of the local network 110. Similarly, every control arbiter 120 itemized in the control arbiter list 156 has a corresponding control arbiter memory block 124 in the shared memory of the local network 110. The robot controllers 140 each communicate with the robot manager configuration 152 to learn of all the control arbiters 120 available to receive commands in the robotics system 100 by getting the control arbiter list 156. Each robot controller 140 publishes a command 440 and a status 144 to its corresponding robot controller memory block 142. The publication of the command 440 and status 144 causes a change in the state of the shared memory via the publish/subscribe system. Each control arbiter 120 wakes up in response to the shared memory change.

Each control arbiter 120 communicates with the robot manager configuration 152 to learn of all the robot controllers 140 in the robotics system 100 by getting the robot controller list 154, and pulls the commands 440 and statuses 144 from all the robot controller memory blocks 142. Each control arbiter 120 sequentially pulls the command 440 and status 144 from each robot controller memory block 142 in the order defined by the robot controller list 154, and, depending on the robot controller status 144, issues the command 440 to one or more of the uncommitted connected resources 120 (e.g. hardware) of that control arbiter 120. Each robot controller 140 has a status 144 of compromising or non-compromising. With a status 144 of compromising, the robot controller 140 is willing to allow issuance of a partial command 440. In contrast, with a status 144 of non-compromising, the robot controller 140 is will only allow issuance of a full command 440.

For example, referring to FIG. 16, the first control arbiter 120A controls an arm resourcel22 having a turret, shoulder, elbow-1, and elbow-2. The robot controllers 140 become informed of the first control arbiter 120A through the nth control arbiter 120N by getting the control arbiter list 156 from the robot manager configuration 152. Each active robot controller 140 receives a command 440 from the behavior system 102 for execution by the control arbitration system 102 and publishes its command 440 its respective robot controller memory block 142. The control arbiters 120 recognize that one or more commands 440 have been published and sequentially pull the commands 440 for execution. The first control arbiter 120A (as designated so by the control arbiter list 156) pulls the command 440 and status 144 of the first robot controller 140A (as designated so by the robot controller list 154) from the respective robot controller memory block 142, which, in this case, contains a command 440 for the shoulder resource 122A-2. The status 144 of the first robot controller 140A is irrelevant because none of the resources 120 have been committed yet. The first control arbiter 120A commits the shoulder resource 122A-2 to the command 440 of the first robot controller 140A.

Next, the first control arbiter 120A pulls the command 440 and status 144 of the second robot controller 140B from the respective robot controller memory block 142, which, in this case, contains a command 440 for the shoulder resource 122A-2 and the turret resource 122A-1 and a status of compromising. Since the shoulder resource 122A-2 was committed to the first robot controller 140A, the first control arbiter 120A will be unable to issue the full command 440 of the second robot controller 140B. Nevertheless, since the second robot controller 140B has a status of compromising, the first control arbiter 120A will be able to issue the command 440 partially, by committing the currently uncommitted turret resource 122A-1 for the command 440 of the second robot controller 140B. The first control arbiter 120A proceeds to sequentially pull the command 440 and status 144 of each successive robot controller 140 in the robot controller list 154 and commit resources 122 in accordance with the status 144 of the respective robot controller 140.

In the example of nth robot controller 140N, the first control arbiter 120A pulls its command 440 and status 144 from the respective robot controller memory block 142, which, in this case, contains a command 440 for the shoulder resource 122A-2, the elbow-1 resource 122A-3 and the elbow-2 resource 122A-4, and a status of non-compromising. Since the shoulder resource 122A-2 was committed to the first robot controller 140A, the first control arbiter 120A will be unable to issue the full command 440 of the nth robot controller 140N. Furthermore, since the nth robot controller 140N has a status of non-compromising, the first control arbiter 120A will be unable to issue the command 440 partially to the uncommitted elbow-1 and elbow-2 resources 122A-3, 122A-4. As a result, the first control arbiter 120A commits no resources 122 for the command 440 from the nth robot controller 140N. The command 440 from the nth robot controller 140N will unit for another cycle when all of the required resources 122 are uncommitted and available.

The first control arbiter 120A continues to step through each robot controller 140 until all of its connected resources 122 are committed. Once all of the connected resources 122 are committed, the control arbiter 120 sends a coherent command to its resources 122 and updates its corresponding control arbiter memory block 124 with state feedback 126 of the resources 122. Each robot controller 140 can pull the state feedback 126 (e.g. asynchronously) of each control arbiter 120 from the corresponding control arbiter memory block 124.

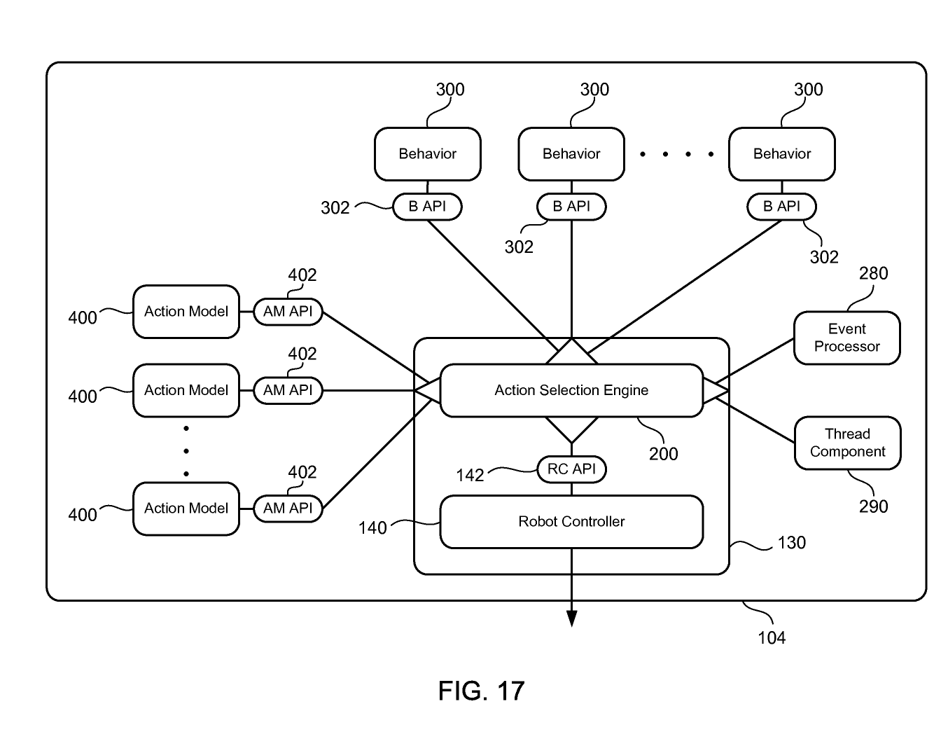

Referring to FIGS. 15 and 17, the behavior system 104 includes at least one application 130. Each application 130 has an action selection engine 200 and a robot controller 140, one or more behaviors 300 connected to the action selection engine 200, and one or more action models 400 connected to action selection engine 200. The behavior system 104 provides predictive modeling and allows the behaviors 300 to collaboratively decide on the robot's actions by evaluating possible outcomes, which will be described later. A behavior 300 is a plug-in component that provides a hierarchical, state-full evaluation function that couples sensory feedback from multiple sources with a-priori limits and information into evaluation feedback on the allowable actions of the robot. Since the behaviors 300 are pluggable into the application 130 (e.g. residing inside or outside of the application 130), they can be removed and added without having to modify the application 130 or any other part of the robotics system 100. Each behavior 300 is a standalone policy. To make behaviors 300 more powerful, it is possible to attach the output of multiple behaviors 300 together into the input of another so that you can have complex combination functions. The behaviors 300 are intended to implement manageable portions of the total cognizance of the robot. To allow for an overall policy for all the behaviors 300, the behavior system 104 provides an event processor 280 (see FIG. 17), which allows an outside component to post a discrete message which will be reliably transmitted to all behaviors 300 and action models 400 at the same time. The actual forwarding of events is performed by an event processing thread owned by the a separate thread component 290. A message is posted by pushing an event into an event priority queue, via the action selection engine 200 or directly to behaviors 300, which can receive and post events. Events can be used to turn on and off behaviors 300, set their modes, etc. The queue permits management of the policy for behaviors 300 without processing them individually.

The action selection engine 200 communicates with the robot controller 140 through the robot controller application programming interface (API) 142, a behavior 300 through a behavior API 302, and an action model 400 through an action model API 402. Abstraction and encapsulation of each component 140, 300, 400 is accomplished through their respective API 142, 302, 402, which provides a manner in which compliant components 140, 300, 400 communicate with the action selection engine 200. The action model API 402 allows various action models 400 to communicate configuration setup including names of resources, states, and the number of actions generated on each action selection cycle 201 to the action selection engine 200.

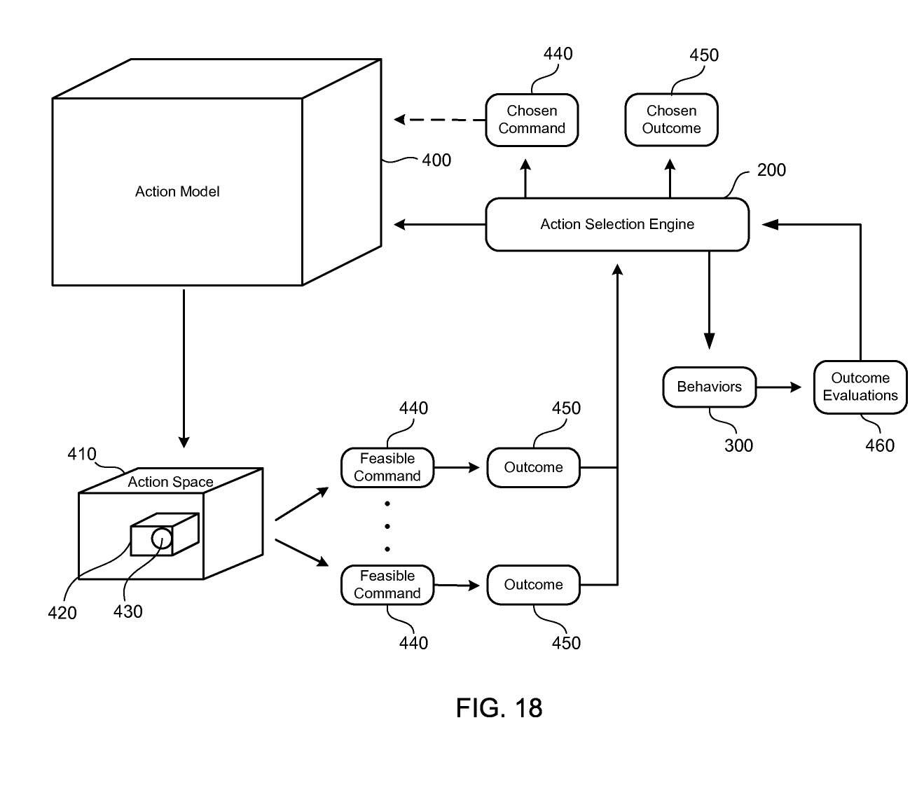

Referring to FIGS. 17 and 18, the action selection engine 200 manipulates events all within one thread, so if a behavior 300 were to send an event to the action selection engine 200 when it receives one, it would end up in a loop. To break this loop, there is an event processor 280. The event processor 280 has a queue of events that builds up events when it receives them, and a thread which periodically sends them all out. This makes it possible for a behavior 300 to post a new event while handling an existing one.

The action selection engine 200 is the coordinating element of the robotics system 100 and runs a fast, optimized action selection cycle 210 (prediction/correction cycle) searching for the best action given the inputs of all the behaviors 300. The action selection engine 200 has three phases: nomination, action selection search, and completion. In the nomination phase, each behavior 300 is notified that the action selection cycle 210 has started and is provided with the cycle start time, the current state, and limits of the robot actuator space. Based on internal policy or external input, each behavior 300 decides whether or not it wants to participate in this action selection cycle 210. During this phase, a list of active behavior primitives 310 is generated whose input will affect the selection of the commands 440 to be executed on the robot.

In the action selection search phase, the action selection engine 200 generates feasible outcomes 450 from the space of available actions, also referred to as the action space 410. The action selection engine 200 uses the action models 400 to provide a pool of feasible commands 440 (within limits) and corresponding outcomes 450 as a result of simulating the action of each commands 440 at different time steps with a time horizon in the future. The action models 400 are standalone components connected to the behavior system 104 and represent part of the robot. The action models 400 each model the state propagation of that part of the system, and provide dynamic, adaptive search windows 420 (see FIG. 18) for available actions during the action selection search phase. During the action selection search phase, each active behavior primitive 310 is presented the same set of outcome options 450 (simulated by the action models 400). Behaviors 300 are standalone components that implement an evaluation heuristic based on an end goal. The evaluation 460 is reported in the form of a scoring function [−1, 1] for each input outcome 450.

The action selection engine 200 executes a randomized search of an action model 400. In the example shown the feasible action space 410 surrounds the current command state 430. The action selection engine 200 uses the action model 400 to predict the expected outcomes 450 of all feasible commands 440 several seconds into the future. When behaviors 300 evaluate these commands 440 (e.g. future system trajectories) based on their expected outcomes 450, they have access to the predicted state evolution over several seconds in the future. The action selection engine 200 calculates a preferred outcome 450, based on the outcome evaluations 450, and sends the corresponding command 400 to the control arbitration system 102 by interfacing with the robot controller 140 of the application 130 to publish commands 440 to the pub/sub system on the network 110, thereby making the commands 440 available to the control arbiters 120 and to receive state feedback 126. The action selection engine 200 also notifies the action model 400 of the chosen commend 440 as feedback.

In the completion phase, the commands 440 that correspond to the collaborative best scored outcome 450 are combined together as an overall command 442, which is presented to the robot controller 140 for execution on the robot resources 122 via their corresponding resource control arbiters 120. The best outcome 450 is provided as feedback to the active behaviors 300, to be used in future evaluation cycles.

An anti-tip behavior 300, 300A executable on the robotics system 100 is configured to prevent the deck assembly 80 from moving outside an operating envelope 12 (FIGS. 11 and 12). The anti-tip behavior 300A is configured to monitor the state of the robot 10 and prevent the robot 10 from tipping over, as during maneuvers in places or while driving (e.g., thereby preventing vehicle roll over during high speed maneuvers). For example, the anti-tip behavior 300A may be configured to prevent a roll over during a high speed turn by limiting the speed of the robot 10. The anti-tip behavior 300A may also be configured to a prevent tip over when going over too step of an incline by causing the robot 10 to back off the incline or move the CG shifter 70 to alter the center of gravity 1050 of the entire robot 10. The operating envelope 12 maybe defined by a foot print and/or lateral extents achievable by the right and left drive track assemblies 30, 40 and the flippers 50, 60. In some implementations, at least one of the flippers 50, 60 is operated as a bumper (e.g., in case the robotic vehicle 10 hits an obstacle, such as a wall, or tips forward onto the flippers). The flippers 50, 60 may be rotated at angle with respect to the chassis 20 to a deployed position in front of the chassis 20. Upon contacting an obstacle the flippers 50, 60 may experience a torque or moment about the front wheel axis 15 greater than a threshold torque, in which a slip clutch (not shown) coupled to the flippers 50, 60 allows rotation of the flippers 50, 60, thus absorbing the impact and dissipating energy of the impact. When the flippers 50, 60 are allowed to rotate via the slip clutch, the linkage 70 (also known as a center of gravity (CG) shifter) moves the deck assembly 80 so that the deck assembly 80 stays within the operating envelope 12, and also so that the center of gravity 1050 of the entire robot 10 stays within the operating envelope 12. For example, a forward face 81 of the deck assembly 80 is kept within the operating envelope 12, even as the robot 10 tilts forward due to an impact with an obstacle. The anti-tip behavior 300A may pivot the flippers 50, 60 back to a deployed position for any additional obstacle encounters. In some implementations, the robot 10 is operated to maintain the center of gravity 1050 of the entire robot 10 within a buffered operating envelope 14, which is the operating envelope 12 minus a buffer distance BD from the boundaries of the operating envelope 12. For example, the forward face 81 of the deck assembly 80 has a threshold forward travel toward the distal tips 51, 61 of the flippers 50, 60, which may be a forward boundary of the operating envelope 12 less a buffer distance BD. The anti-tip behavior 300A can receive sensor data (e.g., position data from encoders on the joints between the flippers 50,60 and the chassis, between the linkage 70 and the chassis 20, and between the linkage 70 and the deck assembly 80) and/or positions of centers of gravity 1000, 1010, 1020, 1030, 1050 of the robot 10 from the dynamics model 170 to determine when various portions of the robot 10 are moving toward or outside of an operating envelope.

In some implementations, the anti-tip behavior 300A has a stop-priority mode such that movement of a commanded component of the robot 10 is stopped before the center of gravity 1050 of the entire robot 10 is allowed to move outside of the operating envelope 12. For example, during execution of the stop-priority mode of the anti-tip behavior 300A, when the robot 10 is commanded such that the center of gravity 1050 of the entire robot 10 approaches a boundary of the operating envelope 12, the operating envelope 12 will remain constant and any moving components of the robot 10 will be stopped from moving the center of gravity 1050 of the entire robot 10 outside of the operating envelope 12. In addition, when the robot 10 is commanded such that the operating envelope 12 is altered and approaches the center of gravity 1050 of the entire robot 10, the operating envelope 12 will be adjusted to maintain the center of gravity 1050 of the entire robot 10 within the operating envelope 12.

When the CG shifter 70 and/or a received articulated payload 500 (e.g., manipulator arm 600) moves the center of gravity 1050 of the entire robot 10 toward the boundary of the operating envelope 12 (e.g., forward boundary edge), the flippers 50, 60 will remain stationary (e.g., via the articulation drive motor) while the CG shifter 70 and/or the received articulated payload 500, 600 are commanded to keep the center of gravity 1050 of the entire robot 10 within the operating envelope 12. In some cases, the robot 10 is command to stop movement the center of gravity 1050 of the entire robot 10 (e.g., gradually or with a deceleration to avoid abrupt movements) from traveling past the threshold forward travel or the buffered operating envelope 14. If the center of gravity 1050 of the entire robot 10 is moved beyond a boundary of the buffered operating envelope 14, yet kept within the operating envelope 12, the robot 10 may be command to move the center of gravity 1050 of the entire robot 10 within the boundary of the buffered operating envelope 14. If the flippers 50, 60 are commanded such that the boundary of the operating envelope 12 moves and approaches the center of gravity 1050 of the entire robot 10 (e.g., as by moving the distal tips 51, 61 of the flippers 50, 60 toward the center of gravity 1050 of the entire robot 10), the flippers 50, 60 will be commanded to move or stop (e.g., gradually or with a deceleration to avoid abrupt movements) to maintain the center of gravity 1050 of the entire robot 10 within the operating envelope 12 or the buffered operating envelope 14.

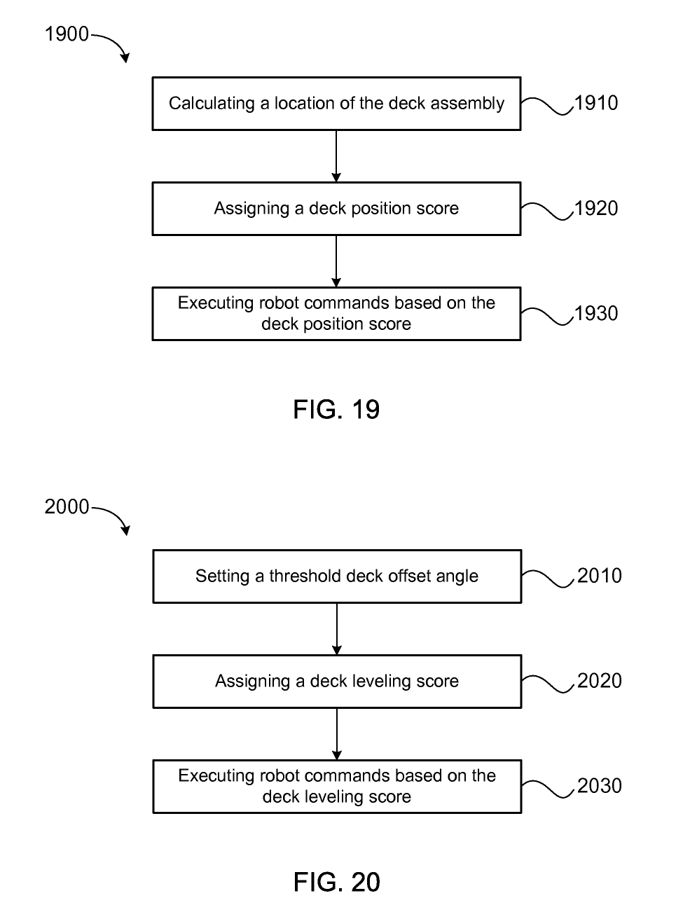

FIG. 19 provides an exemplary flowchart 1900 of an arrangement of operations of the anti-tip behavior 300A. The operations may be executed on the robotics system 100 and/or a computer attached as a payload 500 to the robot 10. Operations include calculating 1910 a location of the deck assembly 80 with respect to the chassis 20 and assigning 1920 a deck position score based on or indicative of a relative position of the deck assembly 80 with respect to the chassis 20. The deck position score may be an outcome evaluation 460 in the form of a scoring function [−1, 1] that represents the favorability of the outcome 450 of the command 440. The action selection engine 200 may use the deck position score or outcome evaluation 460 in determining the overall chosen command 440 for the robot 10. For example, the anti-tip behavior may be configured to calculate a location of the forward face 81 and/or rearward face 83 of the deck assembly with respect to a forward face 21 and/or rearward face 23 of the chassis 20, respectively, the front wheel axis 15, or with respect to the center of gravity 1050 of the entire robot 10. Movement of the deck assembly 80 and/or flippers 50, 60 may be restricted based on the deck position score (e.g., in accordance with a priority mode). For example, the deck position score is initialized at zero with the deck assembly 80 in a neutral position directly above the chassis 20 (e.g., with the CG shifter 70 substantially vertical) and the anti-tip behavior decrements the deck position score as the tips 51, 61 of the flippers 50, 60 and the forward face 81 of the deck assembly 80 approach each other. In some examples, the anti-tip behavior 300A assigns a deck position score of −1.0 if the robot 10 is commanded to move a portion of the deck assembly 80 outside of the operating envelope 12. In some examples, the anti-tip behavior 300A assigns a deck position score of 0.0 if a portion of the deck assembly 80 is outside of the operating envelope 12, but the robot 10 has been commanded such that the deck assembly 80 is moving to a safe position within the operating envelope 12. In some examples, the anti-tip behavior 300A assigns a deck position score of 1.0 if a commanded robot movement causes the deck assembly 80 to stay within the operating envelope 12. When the deck assembly 80 is moved to a “parked” position, as shown in FIG. 14, the flippers 50, 60 can move without restriction (e.g., to any commanded position). Operations further include executing 1930 robot commands based on the deck position score. In some implementations, the anti-tip behavior receives a buffer zone distance, which the anti-tip behavior uses a minimum distance that any point on the forward face 81 of the deck assembly 80 may be disposed with respect to the flippers 50, 60. The anti-tip behavior may be enabled or disabled by the controller 350 via a user command and/or another behavior operating on the controller 350 (e.g., via an event handler).

In some implementations, the anti-tip behavior 300A has a flipper-priority mode such that if flipper movement alters the operating envelope 12 to approach the center of gravity 1050 of the entire robot 10, the robot 10 will be commanded to move the center of gravity 1050 of the entire robot 10 (e.g. via moving the center gravity 1010 of the deck assembly 80 and/or the center of gravity 1030 of the linkage 70) to stay within the changing operating envelope 12. In the stop-priority mode, flipper movement is stopped before the altered operating envelope 12 causes the center of gravity 1050 of the entire robot 10 to move outside of the operating envelope 12. As a result, the flippers 50, 60 may be precluded from reaching a desired commanded position. The flipper-priority mode allows the flippers 50, 60 to be moved to a particular position while moving the center of gravity 1050 of the entire robot 10 to accommodate the flipper movement and any subsequent change in the operating envelope 12. For example, the robot 10 may be commanded to assume a particular pose (example of which are shown in FIGS. 11-14); however, the pose is unattainable without moving the flippers 50, 60 to a particular position, such as with the standing pose of FIG. 12. The flipper-priority mode allows the flippers 50, 60 to be moved to attain the pose and the center of gravity 1050 of the entire robot 10 is adjusted accordingly.

In some implementations, the anti-tip behavior 300A has a CG-priority mode such that if the robot 10 is commanded to move its center of gravity 1050 to a particular position, the operating envelope 12 is adjusted accordingly. For example, if the robot 10 is commanded to move an attached manipulator arm 600 (FIG. 10) to pick up an object in front of the robot 10 with the flippers 50, 60 in a stowed position next to the right and left drive track assemblies 30, 40, the center of gravity 1050 of the entire robot 10 is shifted forward. In the stop-priority mode, the manipulator arm 600 would be precluded from moving the center of gravity 1050 of the entire robot 10 beyond the operating envelope 12, which may preclude the manipulator arm 600 from reaching the object. In the CG-priority mode, the flippers 50, 60 are rotated to a deployed position (e.g., an extended base position, such as in FIG. 10), thus expanding the operating envelope 12 and allowing the center of gravity 1050 of the entire robot 10 to move further forward, yet within the operating envelope 12, so that the manipulator arm 600 can reach the object.

In some implementations, the anti-tip behavior 300A has a no-priority mode which allows the robot 10 to move various components with no one component having priority over the other. For example, the flippers 50, 60, the CG shifter 70 and/or an attached articulated payload (e.g., manipulator arm 600) can all move to alter the operating envelope 12 and move the center of gravity 1050 of the entire robot 10 while keeping the center of gravity 1050 of the entire robot 10 within the operating envelope 12. The anti-tip behavior may monitor the center of gravity 1000 of the chassis 20, the center of gravity 1010 of payload deck assembly 80, the center of gravity 1020 of the flippers 50, 60, the center of gravity 1030 of the linkage 70, and/or the center of gravity 1050 of the entire robot 10 so as to coordinate movement of the components to keep the center of gravity 1050 of the entire robot 10 within the operating envelope 12. In some implementations, the components execute compromised movements that allow all executed commands to be executed. For example, movement of an attached manipulator arms 600 is confined to a path that allows concurrent movement of the flippers 50, 60 to a desired position.

A deck leveling behavior 300B executable on the robotics system 100 is configured to keep the deck assembly 80 substantially level while the CG shifter 70 is moving forwards or backwards. The deck leveling behavior 300B allows a user to command one axis of deck movement (e.g., forwards and backwards) while the behavior 300B causes the robotics system 100 to command two axis of deck movement so that the deck assembly 80 remains substantially level to ground and/or parallel to the chassis 20. The deck leveling behavior 300B may be enabled or disabled by the controller 140 via a user command and/or another behavior 300 operating on the behavior system 104 (e.g., via an event handler). Operations of the deck leveling behavior 300B may include calculating a deck offset angle θ defined as the angle between a longitudinal axis 85 of the deck assembly 80 and ground or a longitudinal axis 25 of the chassis 20 (FIG. 9). The deck offset angle θ may be determined using sensor data, such as position data from encoders on the joints between the linkage 70 and the chassis 20 and between the linkage 70 and the deck assembly 80, and/or positions of centers of gravity 1000, 1010, 1020, 1030, 1050 of the robot 10 from the dynamics model 170. FIG. 20 provides a flowchart 2000 illustrating an exemplary arrangement of operations of the deck leveling behavior 300B. Deck leveling behavior 300B operations may include setting 2010 threshold deck offset angle, which is an amount of acceptable deviation from a level position, and optionally monitoring the deck offset angle θ. Deck leveling behavior operations may also include assigning 2020 a deck leveling score (e.g., outcome evaluation 460) based on the calculated deck offset angle θ. The deck leveling score or outcome evaluation 460 may be in the form of a scoring function [−1, 1]. Movement of the deck assembly 80 and/or flippers 50, 60 may be restricted based on the deck leveling score (e.g., in accordance with a priority mode). For example, the deck leveling score is initialized at zero with the deck assembly 80 in a level position with the longitudinal axis 85 of the deck assembly 80 substantially parallel to ground or to the longitudinal axis 25 of the chassis 20. The deck leveling behavior 300B increases the deck leveling score (e.g., to 1.0) as the deck offset angle θ approaches the level position within the threshold deck offset angle, and decreases the deck leveling score (e.g., to −1.0) as the deck assembly 80 moves beyond the threshold deck offset angle away from the level position. The amount that the deck leveling score is increased or decreased may be proportional to the amount of movement toward or away from the level position. In some implementations, the action selection engine 200 may use the deck position score and/or the deck level score as outcome evaluations 460 of an outcome 450 of a feasible command 440 for selecting a command 440 for execution on the robot 10.

A center of gravity (CG) shifter behavior 300C (also referred to as a deck shifter behavior) executable on the robotics system 100 is configured to prevent the CG shifter 70 and/or the deck assembly 80 from bottoming out (e.g., as by interference with the chassis 20 or ground). The CG shifter behavior 300C prevents the CG shifter 70 from travelling outside of the operating envelope 12. For example, if the robot 10 is driven with the flippers 50, 60 in a deployed position in front of and at an angle with respect to the chassis 20, and the CG shifter behavior would limit forward travel of the CG shifter 70 such that the deck assembly 80 does not extend past the distal tips 51, 61 of the flippers 50, 60. If the robot 10 were to fall forward, the flippers 50, 60 would prevent and protect the deck assembly 80 for contacting the ground (assuming a generally flat ground surface without pointy protrusions that my project upwardly between the flippers 50, 60). The deck or CG shifter behavior 300C may also prevent collision between the deck shifter or linkage 70 and the chassis 20. The center of gravity (CG) shifter behavior 300C may receive sensor data (e.g., position data from encoders on the joints between the flippers 50,60 and the chassis, between the linkage 70 and the chassis 20, and between the linkage 70 and the deck assembly 80) to calculate the centers of gravity 1000, 1010, 1020, 1030, 1050 of the robot 10, and/or receive positions of centers of gravity 1000, 1010, 1020, 1030, 1050 of the robot 10 from the dynamics model 170. In some implementations, the center of gravity (CG) shifter behavior 300C communicates, via the robot controller 140, with the right and left drive modules 1522,1524, CG shifting actuator modules 1526, 1527 (for the linkage 70), and the flipper drive module 1528 over the motor control controller area network (CAN) bus 1520 to control these modules and/or receive sensor data, such as angular position data (e.g., from absolute encoders) of the respective components.

In some implementations, the CG shifter behavior 300C provides an outcome evaluation 460 of an outcome 450 of a feasible command 440 for execution on the robot 10. The outcome evaluation 460 may be in the form of a scoring function [−1, 1]. For example, when the CG shifter 70 is outside or about to travel outside of the operating envelope 12, the CG shifter behavior 300C may provide an outcome evaluation 460 of −1.0. When the CG shifter 70 is inside or travelling back inside of the operating envelope 12, the CG shifter behavior 300C may provide an outcome evaluation 460 of 1.0. If the CG shifter 70 is in a parked position (inside of the operating envelope 12), the CG shifter behavior 300C may provide an outcome evaluation 460 of 0.0. In some implementations, the action selection engine 200 uses the outcome evaluations 460 of the CG shifter behavior 300C for selecting a command 440 for execution on the robot 10.

A stair assist behavior 300D executable on the robotics system 100 is configured to coordinate movement of one or more components of the robot 10 (e.g., the right and left drive track assemblies 30, 40, the flippers 50, 60, the CG shifter 70, and the deck assembly 80) to cause the robot to negotiate steps or stairs. The stair assist behavior 300D may receive sensor data (e.g., position data from encoders on the joints between the flippers 50,60 and the chassis, between the linkage 70 and the chassis 20, and between the linkage 70 and the deck assembly 80) to calculate the centers of gravity 1000, 1010, 1020, 1030, 1050 of the robot 10, and/or receive positions of centers of gravity 1000, 1010, 1020, 1030, 1050 of the robot 10 from the dynamics model 170 to coordinate movement of the robot components for negotiating stairs. Other sensor data may include constant signals from contact sensors in the chassis 20, right and left drive track assemblies 30, 30, flippers 50, 60 and/or deck assembly 80, and/or proximity data from proximity sensors in the front and/or rear sensor pods 88, 89. In some implementations, the stair assist behavior 300D communicates, via the robot controller 140, with the right and left drive modules 1522,1524, CG shifting actuator modules 1526, 1527 (for the linkage 70), and the flipper drive module 1528 over the motor control controller area network (CAN) bus 1520 to control these modules and/or receive sensor data, such as angular position data (e.g., from absolute encoders) of the respective components. The stair assist behavior 300D may have a stair climb mode and a stair descent mode.

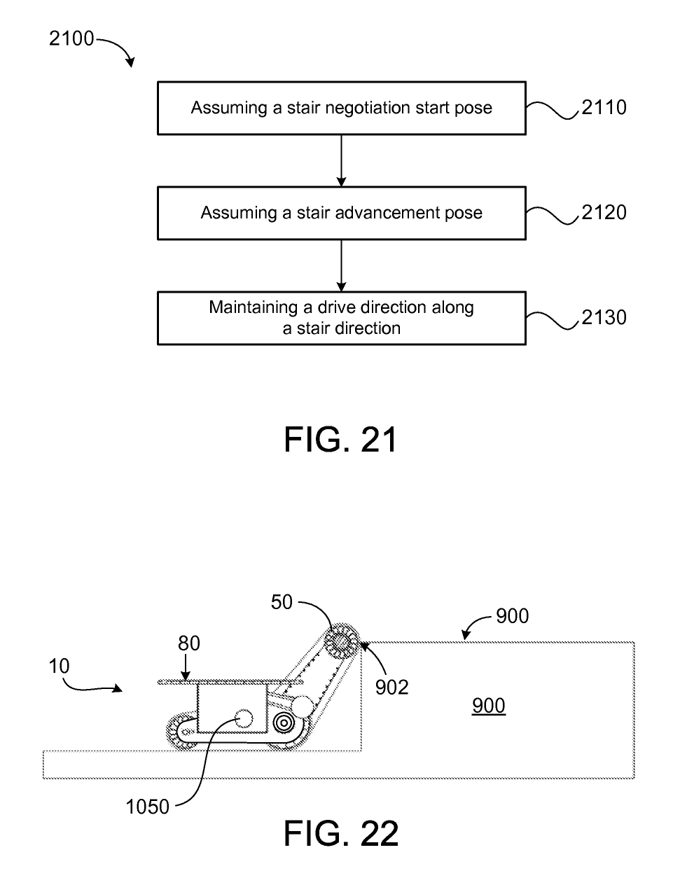

FIG. 21 provides a flowchart 210 of an exemplary arrangement of operations of the stair assist behavior 300D. The stair assist behavior operations include assuming 2110 a stair negotiation start pose, as by moving the flippers 50, 60 and the CG shifter 70. In the stair climb mode, the stair negotiation start pose may be assumed by moving the flippers 50, 60 to a deployed position in front of and at an angle with respect to the chassis 20, and moving the CG shifter 70 to a position that places the center of gravity 1050 of the overall robot 10 in a stable position for stair climbing. Stable positions for the center of gravity 1050 of the overall robot 10 for stair climbing may be achieved when the CG shifter 70 and deck assembly 80 are in the parked position or when the center of gravity 1010 of the deck assembly 80 and the center of gravity 1030 of the linkage 70 are forward of the center of gravity 1000 of the chassis 20 and rearward of the center of gravity 1020 of the flippers 50, 60. In the stair descent mode, the stair negotiation start pose entail assuming a similar pose as that for the stair climb mode, but with the flippers 50, 60 at a deployed position substantially parallel to the chassis 20 or slightly inclined from parallel. Operations of the stair assist behavior 300D further include assuming 2120 a stair advancement pose. In the stair climb mode, the stair advancement pose may be assumed by moving the flippers 50, 60 and the CG shifter 70 to a climb pose when the mount of the stairs is detected. In some implementations, the stair advancement pose entails positioning the center of gravity 1010 of the deck assembly 80 and optionally the center of gravity 1030 of the linkage 70 forward of the center of gravity 1000 of the chassis 20 and at least above, if not forward of the center of gravity 1020 of the flippers 50, 60. The stair assist behavior operations also include maintaining 2130 direction along a stair direction straight up the stairs while climbing the stairs. The stair assist behavior 300D may be configured to limit a commanded turn rate, if the turn rate exceeds a threshold turn amount away from the stair direction.

The stair assist behavior 300D may provide an outcome evaluation 460 of an outcome 450 of a feasible command 440 for execution on the robot 10. The outcome evaluation 460 may be in the form of a scoring function [−1, 1]. For example, the stair assist behavior 300D may provide an outcome evaluation 460 of −1.0 when the outcome 450 of the feasible command 440 moves the robot 10 away from or remain out of a stable position or a desired pose. The stair assist behavior 300D may provide an outcome evaluation 460 of 1.0 when the outcome 450 of the feasible command 440 moves the robot 10 toward or to stay in a stable position or a desired pose. In some implementations, the action selection engine 200 uses the outcome evaluations 460 of the stair assist behavior 300D for selecting a command 440 for execution on the robot 10.

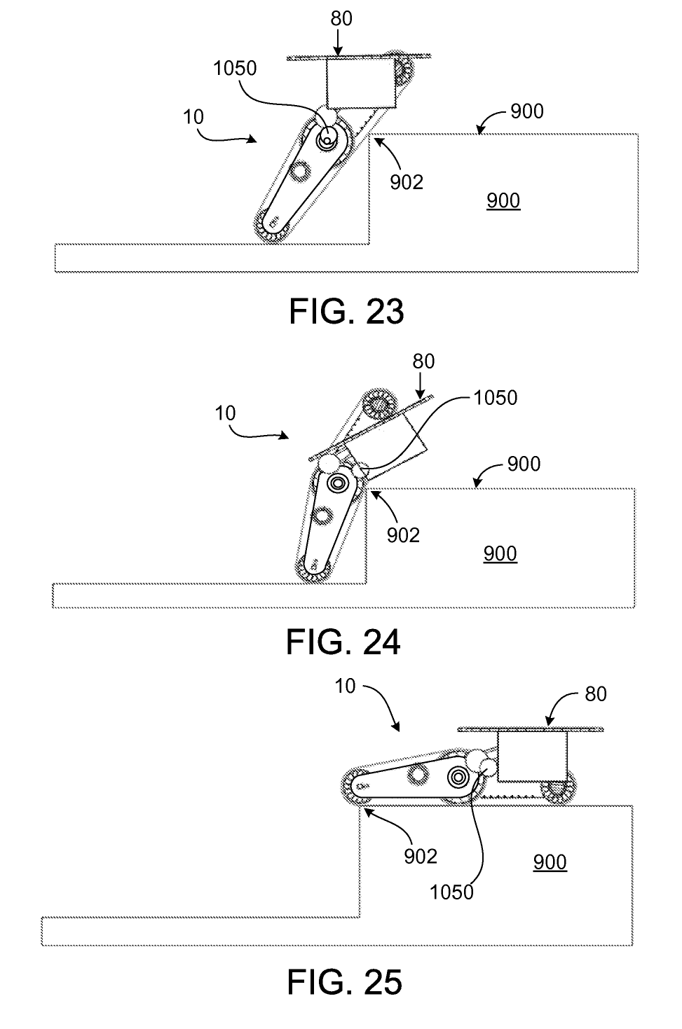

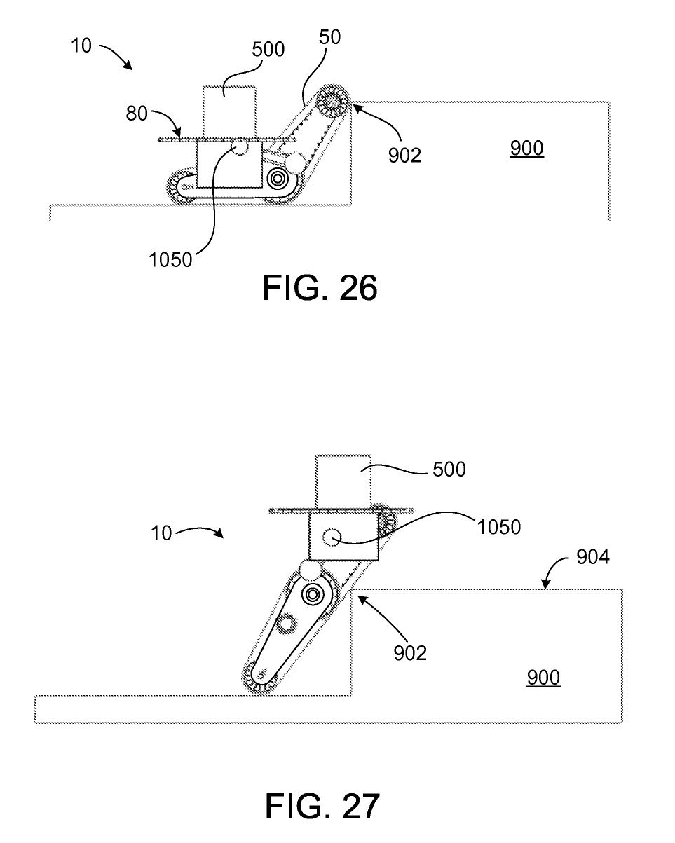

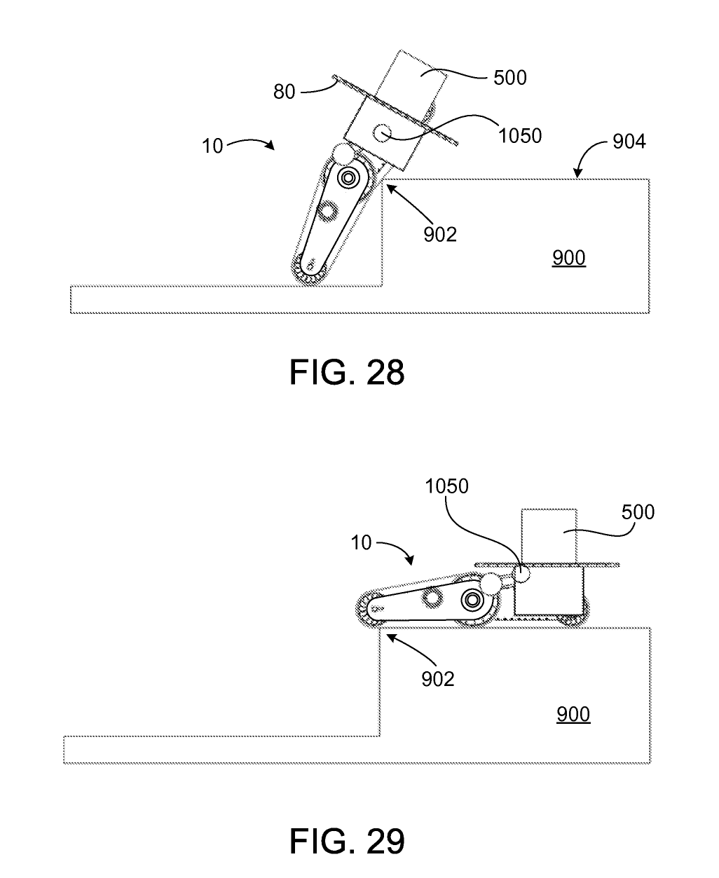

FIGS. 22-25 illustrate the robotic vehicle 10 executing the stair assist behavior 300D in the stair climb mode to climb a step 900. The robotic vehicle 10 uses the independently controllable pivot drivers 72 and 74 to control both fore-aft position and pitch orientation of the deck assembly 80 with respect to the chassis 20 to selectively displace the center of gravity 1010 of the payload deck assembly 80 both forward and rearward of the center of gravity 1000 of the chassis 20, thereby shifting the over-all center of gravity 1050 of the robotic vehicle 10. Each pivot driver 72, 74 may include a position sensor (e.g., absolute encoder) for determining an angular position of the deck assembly 80 with respect to the chassis 20. Referring to FIG. 22, the robotic vehicle 10 initiates step climbing by pivoting the first and second flippers 50 and 60, respectively, upward to engage the edge 902 of the step 900. The robotic vehicle 10 also positions the center of gravity 1010 of the deck assembly 80 above the front end 21 of chassis 20. Next, as shown in FIGS. 23 and 24, the robotic vehicle 10 pivots the first and second flippers 50 and 60 downward on the edge 902 of the step 900 to engage the top 904 of the step and drives forward. In FIG. 23, the deck assembly 80 is further tilted to advance the center of gravity 1050 of the robot 10 (permitting higher obstacles to be climbed). The robotic vehicle 10 continues to displace the center of gravity 1010 of the payload deck assembly 80 beyond the front of the chassis 20, as shown in FIG. 24, by rotating both the first and second pivots, 71 and 73 respectively. Finally, as shown in FIG. 25, the robotic vehicle 10 drives forward to pull the chassis 20 over the edge 902 of the step 900. FIGS. 26-29 illustrates the robotic vehicle 10 executing the stair climb assist behavior 300D with a functional payload 500 secured to the payload deck assembly 80. In this case, the center of gravity of the payload 500 is used for shifting the center of gravity 1050 of the overall robot 10 during the maneuvers. The robotic vehicle 10 may execute a similar set of actions in a substantially order for executing the stair assist behavior 300D in the stair descent mode to descend off of a step 900.

A payload manager behavior 300E executable on the robotics system 100 is configured to monitor and/or report on connected payloads 500 (e.g., to the network 110). In some implementations, the connected payload 500 determines which payload port or pad 810 it is connected to and then reports (e.g., to the network 110) the information using the service and configuration registries. In some examples, if a payload 500 requires some action to be taken by the control arbitration system 102, a property may be set that specifies a script corresponding to a payload ID of the received payload 500 for execution by the robotics system 100. Arguments for the script may include a payload port number and IP address of the payload 500. In some implementations, the payload manager behavior 300E communicates, via the robot controller 140, over the power—auxiliary sensors—payload deck CAN bus 1510 to the power and auxiliary sensors signal processor 1512 and the payload deck signal processor 1514. The payload manager behavior 300E can monitor, via the power and auxiliary sensors signal processor 1512, any auxiliary sensors as well as the power source type, temperature, and available power level for each power source 90 connected to the signal processor 1512. The payload manager behavior 300E can monitor, via the payload deck signal processor 1514, the power source type, temperature, and available power level for each power source 90 connected to the payload deck assembly 80. When multiple power sources 90 are installed on the robotic vehicle 10 (i.e. on the chassis 20 and/or the payload deck 80), power management control logic detects via the auxiliary sensors signal processor 1512 and the payload deck signal processor 1514 the power source type, temperature, and available power level for each power source 90. The payload manager behavior 300E can monitor and/or control the auxiliary sensors signal processor 1512 and the payload deck signal processor 1514, which each control recharging of an associated power source 90 based on power source type, temperature, and available power level for each power source 90.

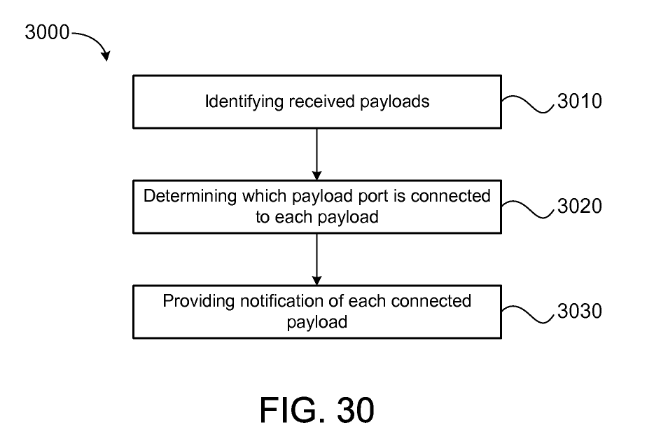

FIG. 30 provides a flowchart 3000 of an exemplary arrangement of operations of the payload manager behavior 300E. The payload manager behavior operations include identifying 3010 received payloads 500 on the robot 10 and determining which payload port (e.g., of a payload connector 810) each payload is connected to, as by providing an internet protocol (IP) or private internet protocol (PIP) service that allows such a determination. The payload manager behavior operations also include providing 3030 notification of each connected payload 500. The payload manager behavior 300E may notify the robotics system 100 of the connected payloads 500, as by publishing the notification to the network 110. The notification may in the form of an integer vector specifying a payload type and payload port number.

An assisted teleoperation behavior 300F executable on the robotics system 100 is configured to prevent an operator from maneuvering the robot 10 into obstacles. The assisted teleoperation behavior 300E receives inputs from obstacle detection and obstacle avoidance sensors (e.g., the front and rear sensor pods 88, 89) and evaluates an outcome 450 of the current robot command 440. The assisted teleoperation behavior 300F causes the robot 10 to institute obstacle avoidance measures (e.g., stop or turn away from obstacles) before the robot 10 reaches the obstacle. An obstacle is a physical or non-physical impediment that interferes with the proper functioning of the robot. Obstacles include physical objects, cliffs, adverse localized environmental conditions (e.g. hot temperature spot or high radiation area), etc. In some implementations, the assisted teleoperation behavior 300F is disabled for manual override control of the robot's resources (e.g., flippers 50, 60, CG shifter 70, payload 500, etc.).

The assisted teleoperation behavior 300F may provide an outcome evaluation 460 (e.g., in the form of a scoring function [−1, 1]) of an outcome 450 of a feasible command 440 for execution on the robot 10. For example, the assisted teleoperation behavior 300F may provide an outcome evaluation 460 of −1.0 when the outcome 450 of the feasible command 440 moves the robot 10 toward or into a detected obstacle. The assisted teleoperation behavior 300F may provide an outcome evaluation 460 of 1.0 when the outcome 450 of the feasible command 440 moves the robot 10 away from or not within a danger zone (e.g., buffer distance) of a detected obstacle. In some implementations, the action selection engine 200 uses the outcome evaluations 460 of the assisted teleoperation behavior 300F for selecting a command 440 for execution on the robotic vehicle 10.

Referring again to FIG. 15A, an overall command 442 for execution on the robotic vehicle 10 is presented to the robot controller 140 for execution on the robot resources 122 via their corresponding resource control arbiters 120. When the overall command 442 includes one or more commands 440 for the right and left drive track assemblies 30, 40 of the robotic vehicle 10, an axis-to-motor-map module 192 may be implemented at a lower level than the behaviors 300 for interaction with the arbiter(s) 120. When the overall command 442 contains drive commands 440 in terms of rotate and translate, these commands must be converted into right and left drive commands 440 for the respective right and left motor drivers 36, 46 of the right and left drive track assemblies 30, 40. The axis-to-motor-map module 192 converts the rotate and translate drive commands 440 into right and left drive commands 440 while taking into account the acceleration/deceleration limits of the motor drivers 36, 46 and modifying the right and left drive commands 440, if necessary, so as not to command the motor drivers 36, 46 to accelerate/deceleration at a rate beyond their limits. The axis-to-motor-map module 192 may communicate with the peak load balancing module 190 while modifying the right and left drive commands 440 to stay within power limits of the power source 90. If the axis-to-motor-map module 192 receives rotate and translate drive commands 440 that convert into right and left drive commands 440 each having an acceleration less than an acceleration limit (e.g., default of 200 rad/ŝ2), then the right and left drive commands 440 are not modified for accommodating acceleration limits of the motor drivers 36, 46. Otherwise, the axis-to-motor-map module 192 modifies the right and left drive commands 440 to stay within the acceleration limits of the motor drivers 36, 46.

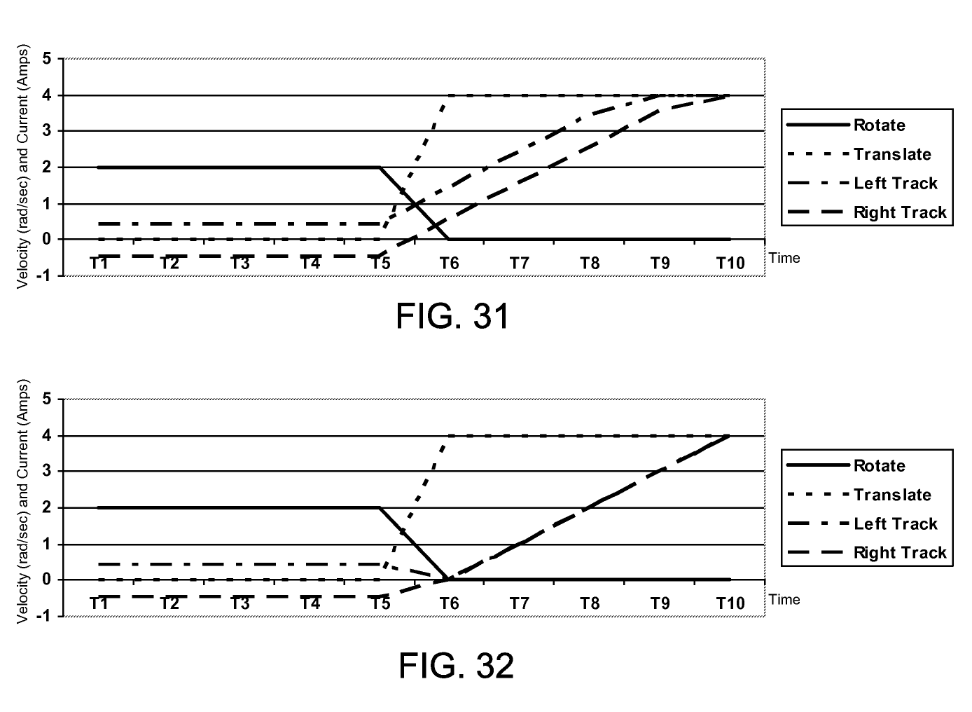

FIGS. 31-36 illustrate three of four examples of the axis-to-motor-map module 192 modifying the converted right and left drive commands 440 to either stay within acceleration/deceleration limits of the motor drivers 36, 46 and/or to stay within power limits of the power source 90. The y-axis of the graphs provides velocities for rotate and translate commands in rad/sec as well as left and right drive motor currents in amps. The x-axis of the graphs provides time in seconds. The examples include: 1) accelerating the robotic vehicle 10 straight forward or backward coming out of a turn; 2) decelerating the robotic vehicle 10 to a stop coming out of a turn (e.g., letting go of the joystick of an operator control unit (OCU)); 3) turning the robotic vehicle 10 while accelerating/decelerating; and 4) a default of limiting left track and right track velocity such that neither left track or right track accelerations exceed 200 rad/ŝ2.

Referring to FIGS. 31 and 32, in some implementations, the axis-to-motor-map module 192 modifies the converted right and left drive commands 440 for accelerating straight forward or backward coming out of a turn when 1) commanded rotate is zero, 2) left track speed is not equal to right track speed, and 3) translate acceleration is greater than zero. FIG. 31 illustrates the unmodified converted right and left drive commands 440, while FIG. 32 illustrates the modified converted right and left drive commands 440. In the example shown, from time T1-T5, the robot 10 is turning clockwise in place. At time T5, the rotate command drops to zero, and the translate command jumps to a maximum or threshold translate amount. At time T5, the left track speed is not equal to right track speed because the robot 10 was just turning. To remedy this, the axis-to-motor-map module 192 modifies the commands to accelerate the slower track 30 (i.e., the right motor driver 36) and decelerate the faster track 40 (i.e., the left motor driver 46) until the two track speeds are equal, then the axis-to-motor-map module 192 modifies the commands to accelerate both of motor drivers 36, 46 together until the robot's velocity reaches the commanded translate velocity. The modified commands 440 allow the robot 10 to stop turning and start going straight forward or back as soon as possible. Unmodified, the commands 440 may cause the robot 10 to turn the entire time it is accelerating to the commanded translate velocity.

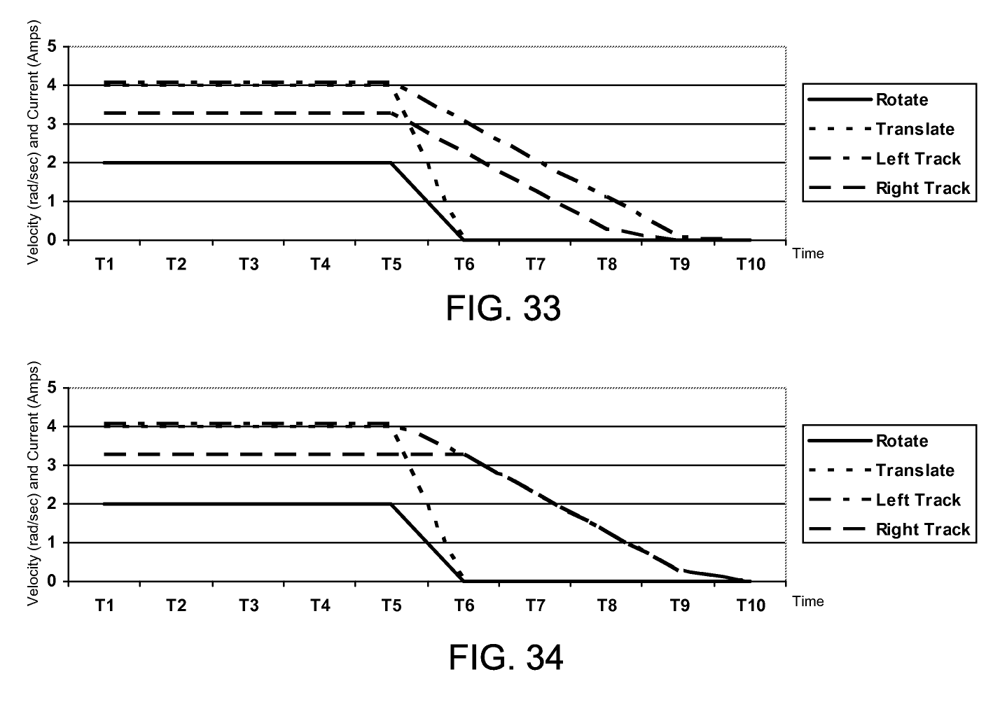

Referring to FIGS. 33 and 34, in some implementations, the axis-to-motor-map module 192 modifies the converted right and left drive commands 440 for decelerating to a stop coming out of a turn when 1) commanded rotate is zero, 2) left track speed is not equal to right track speed, and 3) translate acceleration is less than zero. FIG. 33 illustrates the unmodified converted right and left drive commands 440, while FIG. 34 illustrates the modified converted right and left drive commands 440. In the example shown, from time T1-T5, the robot 10 is at a maximum or threshold velocity in a clockwise circular motion. At time T5, both rotate and translate commands drop to zero. At time T5, the left track speed is not equal to right track speed because the robot 10 was just turning. To remedy this, the axis-to-motor-map module 192 modifies the commands to decelerate the faster track 40 (i.e., the left motor driver 46) while holding the slower track 30 (i.e., the right motor driver 36) at a steady velocity until the speeds of the two tracks 30, 40 are equal, then the axis-to-motor-map module 192 modifies the commands to decelerate both of the motor drivers 36, 46 together until the robot's velocity reaches zero (or until the next command is received). The modified commands 440 allow the robot 10 to stop turning and decelerate in a straight line as soon as possible. Unmodified, the commands 440 may cause the robot 10 to turn the entire time it is decelerating to a stop.

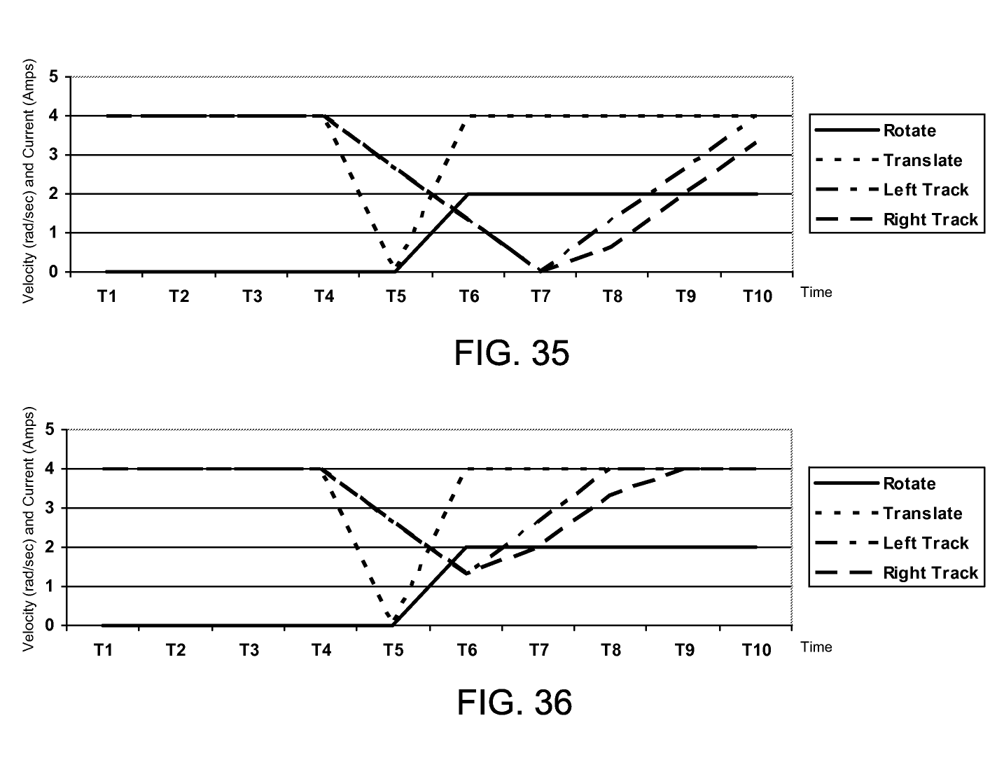

Referring to FIGS. 35 and 36, in some implementations, the axis-to-motor-map module 192 modifies the converted right and left drive commands 440 for turning while accelerating/decelerating when 1) error between the commanded rotate and the last measured rotate is greater than a threshold value, 2) the translate acceleration is not equal to zero, and 3) the current translate velocity is greater than a minimum or threshold velocity required before a rotate priority is allowed to occur. FIG. 35 illustrates the unmodified converted right and left drive commands 440, while FIG. 36 illustrates the modified converted right and left drive commands 440. In the example shown, from time T1-T4, the robot 10 is at maximum translate and not turning. At time T4, the translate command drops to zero. The right and left track assemblies 30, 40 start decelerating, and before deceleration is complete, maximum translate and rotate commands are received at T5. In some examples, when the motor drivers 36, 46 receive both translate and rotate commands that result in an acceleration, they want to complete the translate acceleration/deceleration first before performing the rotate. This results in poor turning sensitivity when driving at a maximum or threshold acceleration. To remedy this, the axis-to-motor-map module 192 modifies the commands to give priority to any commanded rotate, and only accelerate the translate command when the measured rotate is within a certain small margin of error from the commanded rotate. This modification increases the responsiveness of the robot 10 when any rotate command is received while at the maximum or threshold acceleration. Without modified of the commands 440, the robot's response to any rotate command may largely be ignored until translate acceleration is at or nearing zero, resulting in poor drivability. Without the third condition of the translate velocity being greater than a required minimum velocity and with the robot 10 at a stationary position, when a turn at an acceleration greater than the acceleration limit is commanded, the robot 10 may turn (or rotate) in place momentarily before any translate occurs, due to rotate priority. In some examples, a minimum or threshold velocity (e.g., 1 m/s) is required before rotate priority is enabled. If the translate velocity does not exceed the threshold velocity, then no priority is given to the rotate command (when the desired acceleration is greater than the acceleration limit).

The fourth example includes a default feature of the axis-to-motor-map module 192 that limits left and right track velocities such that neither track acceleration exceed 200 rad/ŝ2. The axis-to-motor-map module 192 receives commanded right and left track accelerations, determines a ratio of the commanded right track acceleration to the commanded left track acceleration and adjusts the robot's left and right track velocities so that the faster accelerating track assembly 30, 40 is limited at 200 rad/ŝ2 and the slower accelerating track assembly 30, 40 is less by a factor equal to that of the acceleration ratio.

The axis-to-motor-map module 192 not only improves drivability and user responsiveness of the robot 10, but may also improve drive efficiency of the robot 10, so as to stay within power limits of the power source 90. The axis-to-motor-map module 192 may operate in parallel or series with the peak power load balancing module 190 to provide modified commands for execution on the robot 10. For example, the left and right drive motor commands may be modified by the peak power load balancing module 190 to maintain the current (or power) draw on the power source 90 within acceptable limits (e.g., so as not to under-volt or fail to supply enough power to the robot 10).

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

Embodiments of the subject matter and the functional operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer program products, i.e., one or more modules of computer program instructions encoded on a computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more of them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal, that is generated to encode information for transmission to suitable receiver apparatus.

A computer program (also known as a program, software, software application, script, or code) can be written in any form of programming language, including compiled or interpreted languages, and it can be deployed in any form, including as a stand alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio player, a Global Positioning System (GPS) receiver, to name just a few. Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described is this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specifics, these should not be construed as limitations on the scope of the invention or of what may be claimed, but rather as descriptions of features specific to particular embodiments of the invention. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations or actions are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

A detailed description of autonomous behaviors and other details and features combinable with those described herein may be found in U.S. patent application Ser. No. 11/748,363, filed on May 14, 2007, the entire contents of which is hereby incorporated by reference.

A number of implementations of the invention have been described. Nevertheless, it will be understood that various modifications may be made without departing from the spirit and scope of the invention. For example, flippers of varied length and payload decks with other means of functional payload attachment, such as snap-on, clamps, and magnets. Accordingly, other implementations are within the scope of the following claims.

What is claimed is:

1. A mobile robot comprising:
a chassis;
a drive system disposed on the chassis and configured to maneuver the robot over a work surface;
a deck system comprising:
a payload deck configured to receive a removable payload; and
a deck shifter configured to move the payload deck relative to the chassis; and
a control system connected to the drive system and the deck system, the control system comprising a control arbitration system and a behavior system in communication with each other, the behavior system executing an anti-tip behavior configured to evaluate and provide an outcome evaluation on a predicted outcome of a robot command, the control arbitration system selecting and executing a robot command based at least in part on the outcome evaluation;
wherein the anti-tip behavior evaluates the predicted outcome based on a robot tip-over criteria.

2. The mobile robot of claim 1, wherein the anti-tip behavior determines a payload deck position relative to the chassis and provides the outcome evaluation based at least in part on the payload deck position.

3. The mobile robot of claim 1, wherein the anti-tip behavior determines a position of a center of gravity of the payload deck relative to a center of gravity of the chassis and provides the outcome evaluation based at least in part on the position of the center of gravity of the payload deck.

4. The mobile robot of claim 1, wherein the anti-tip behavior determines a position of a center of gravity of the entire robot relative to an operating envelope, and provides the outcome evaluation based at least in part on the position of the center of gravity of the entire robot.

5. The mobile robot of claim 4, wherein the drive system comprises:
a skid steer drive system disposed on the chassis, the chassis having a leading end, a trailing end, and a center of gravity therebetween; and
right and left driven flippers disposed on corresponding sides of the chassis, each flipper having a pivot end, a distal end, and a center of gravity therebetween, and each flipper being pivotable about a first pivot axis common with a drive axis at the leading end of the chassis;
wherein the lateral extents between the distal ends of the flippers and the trailing ends of the skid steer drive system defines the operating envelope.

6. The mobile robot of claim 5, wherein the deck shifter comprises a linkage having a pivot end, a distal end, and a center of gravity therebetween, and pivotable about a second pivot axis substantially at the leading end of the chassis, the payload deck having a mid pivot point, a leading end and a trailing end, and a center of gravity between the two ends, the payload deck being pivotable about a third pivot axis substantially at the distal end of the linkage, the anti-tip behavior monitoring the centers of gravity of the chassis, the flippers, the linkage, the payload deck, and any received payloads to determine the center of gravity of the entire robot.

7. The mobile robot of claim 5, wherein the anti-tip behavior comprises a stop-priority mode that prevents movement of the center of gravity of the entire robot outside of the operating envelope.

8. The mobile robot of claim 8, wherein the stop-priority mode of the anti-tip behavior prevents movement of the center of gravity of the entire robot inside a threshold distance of a boundary of the operating envelope.

9. The mobile robot of claim 5, wherein the anti-tip behavior comprises a flipper-priority mode that maintains the center of gravity of the entire robot inside the operating envelope when a robot command moves the flippers and thus alters the operating envelope.

10. The mobile robot of claim 5, wherein the anti-tip behavior comprises a center-of-gravity-priority mode that alters the operating envelope by pivoting the flippers with respect to the chassis to maintain the center of gravity of the entire robot inside the operating envelope.

11. The mobile robot of claim 1, wherein the behavior system executes a payload manager behavior that reports received payloads to the control system.

12. The mobile robot of claim 11, wherein the payload deck comprises connection points for both a payload power link and a payload communication link.

13. The mobile robot of claim 11, wherein the payload deck comprises multiple payload connection pads positioned to accommodate selective connection of multiple payload units to the payload deck, each connection pad includes connection points for both payload power and payload communication.

14. The mobile robot of claim 1, wherein the control system comprises:
at least one control arbiter controlling the drive system and at least one control arbiter controlling the deck system;
multiple applications in communication with the control arbiters, each application comprising:
a robot controller in communication with the control arbiters;
an action selection engine in communication with robot controller, the action selection engine periodically executing an action selection cycle to generate an overall command which is sent to the robot controller for execution on the robot resources;
at least one behavior in communication with the action selection engine; and
at least one action model in communication with the action selection engine, each action model modeling at least one of the robot resources and having at least one action space; and
a robot manager in communication with the applications and the control arbiters, the robot manager implementing an application priority policy for determining which application has exclusive control of any one or more of the robot resources at a given time;
wherein the action selection cycle comprises:
selecting a command for each action space of each action model;
generating the single overall command based on the accumulated commands for each action model; and
sending the overall command to the robot controller.

15. A mobile robot comprising:
a chassis;
a drive system disposed on the chassis and configured to maneuver the robot over a work surface;
a deck system comprising:
a payload deck configured to receive a removable payload; and
a deck shifter configured to move the payload deck relative to the chassis; and
a control system connected to the drive system and the deck system, the control system comprising a control arbitration system and a behavior system in communication with each other, the behavior system executing a deck-leveling behavior configured to evaluate and provide an outcome evaluation on a predicted outcome of a robot command, the control arbitration system selecting and executing a robot command based at least in part on the outcome evaluation;
wherein the deck-leveling behavior maintains the payload deck substantially parallel to at least one of the chassis and the work surface.

16. The mobile robot of claim 15, wherein the deck-leveling behavior determines a deck offset angle of the payload deck relative to at least one of a longitudinal axis of the chassis and the work surface, the deck-leveling behavior providing its outcome evaluation based on a difference between the deck offset angle and a threshold angle.

17. The mobile robot of claim 15, wherein the deck-leveling behavior is configured to allow a user command for single axis movement of the deck system while maintaining the payload deck substantially parallel to at least one of the chassis and the work surface.

18. A mobile robot comprising:
a chassis;
a drive system disposed on the chassis and configured to maneuver the robot over a work surface;
a deck system comprising:
a payload deck configured to receive a removable payload; and
a deck shifter configured to move the payload deck relative to the chassis; and
a control system connected to the drive system and the deck system, the control system comprising a control arbitration system and a behavior system in communication with each other, the behavior system executing a deck shifter behavior;
wherein the deck shifter behavior influences execution of commands by the control arbitration system to avoid unintentional contact of the deck shifter and the payload deck with at least one of the chassis and the work surface.

19. The mobile robot of claim 18, wherein the drive system comprises:
a skid steer drive system disposed on the chassis, the chassis having a leading end and a trailing end; and
right and left driven flippers disposed on corresponding sides of the chassis, each flipper having a pivot end and a distal end, each flipper being pivotable about a first pivot axis common with a drive axis at the leading end of the chassis, the deck shifter behavior preventing movement of a leading end of the payload deck forward of the distal tips of the flippers.

20. The mobile robot of claim 19, wherein the deck shifter comprises a linkage having a pivot end and a distal end, the linkage being pivotable about a second pivot axis substantially at the leading end of the chassis, the payload deck having a mid pivot point, a leading end and a trailing end, the payload deck being pivotable about a third pivot axis substantially at the distal end of the linkage, the deck shifter behavior preventing collision between the linkage and the chassis.

21. A mobile robot comprising:
a chassis;
a drive system disposed on the chassis and configured to maneuver the robot over a work surface;
a deck system comprising:
a payload deck configured to receive a removable payload; and
a deck shifter configured to move the payload deck relative to the chassis; and
a control system connected to the drive system and the deck system, the control system comprising a control arbitration system and a behavior system in communication with each other, the behavior system executing a stair assist behavior;
wherein the stair assist behavior coordinates movement of the drive system and the deck system executed by the control arbitration system for negotiating stairs.

22. The mobile robot of claim 21, wherein operations of the stair assist behavior comprise:
assuming a stair negotiation start pose;
assuming a stair advancement pose; and
maintaining a dive direction along a stair direction.

23. The mobile robot of claim 22, wherein the drive system comprises:
a skid steer drive system disposed on the chassis, the chassis having a leading end, a trailing end, and a center of gravity therebetween; and
right and left driven flippers disposed on corresponding sides of the chassis, each flipper having a pivot end, a distal end, and a center of gravity therebetween, and each flipper being pivotable about a first pivot axis common with a drive axis at the leading end of the chassis;
wherein assuming the stair negotiation start pose comprises moving the flippers to a deployed position in front of and at an angle with respect to the chassis.

24. The mobile robot of claim 23, wherein assuming the stair negotiation start pose further comprises moving a center of gravity of the entire robot to a stable position.

25. The mobile robot of claim 24, wherein assuming the stable position comprises moving the payload deck to a parked position adjacently above the chassis.

26. The mobile robot of claim 24, wherein assuming the stable position comprises moving centers of gravity of the payload deck and the deck shifter forward of the center of gravity of the chassis and rearward of the center of gravity of the flippers.

27. The mobile robot of claim 23, wherein assuming the stair advancement pose comprises positioning a center of gravity of the payload deck forward of the center of gravity of the chassis and above the center of gravity of the flippers.

28. The mobile robot of claim 23, wherein assuming the stair advancement pose further comprises positioning the center of gravity of the payload deck forward of the center of gravity of the flippers.

29. The mobile robot of claim 23, wherein maintaining a dive direction comprises limiting a commanded turn rate to a threshold turn rate away from the stair direction.

30. The mobile robot of claim 23, wherein the deck shifter comprises a linkage having a pivot end, a distal end, and a center of gravity therebetween, and pivotable about a second pivot axis substantially at the leading end of the chassis, the payload deck having a mid pivot point, a leading end and a trailing end, and a center of gravity between the two ends, the payload deck being pivotable about a third pivot axis substantially at the distal end of the linkage, the stair assist behavior monitoring the centers of gravity of the chassis, the flippers, the linkage, the payload deck, and any received payloads to determine the center of gravity of the entire robot.

31. A method of controlling a robot, the method comprising:
determining an operating envelope of the robot, the robot comprising:
a chassis;
a drive system disposed on the chassis and configured to maneuver the robot over a work surface; and
a deck system comprising a payload deck configured to receive a removable payload and a deck shifter configured to move the payload deck relative to the chassis;
determining a position of a center of gravity of the entire robot with respect to the operating envelope, the center of gravity of the entire robot comprising at least a center of gravity of the chassis and a center of gravity of the payload deck movable with respect to the chassis; and
maintaining the center of gravity of the entire robot within the operating envelope.

32. The method of claim 31, wherein the drive system comprises:
a skid steer drive system disposed on the chassis, the chassis having a leading end, a trailing end, and its center of gravity therebetween; and
right and left driven flippers disposed on corresponding sides of the chassis, each flipper having a pivot end, a distal end, and a center of gravity therebetween, and each flipper being pivotable about a first pivot axis common with a drive axis at the leading end of the chassis;
wherein the lateral extents between the distal ends of the flippers and the trailing ends of the skid steer drive system defines the operating envelope.

33. The method of claim 32, further comprising preventing movement of a leading end of the payload deck forward of the distal tips of the flippers.

34. The method of claim 32, wherein the deck shifter comprises a linkage having a pivot end, a distal end, and a center of gravity therebetween, and pivotable about a second pivot axis substantially at the leading end of the chassis, the payload deck having a mid pivot point, a leading end and a trailing end, and a center of gravity between the two ends, the payload deck being pivotable about a third pivot axis substantially at the distal end of the linkage, the method further comprising monitoring the centers of gravity of the chassis, the flippers, the linkage, the payload deck, and any received payloads to determine the center of gravity of the entire robot.

35. The method of claim 34, further comprising preventing a collision between the linkage and the chassis.

36. The method of claim 32, further comprising maintaining the center of gravity of the entire robot inside the operating envelope when the flippers are moved, the flipper movement altering the operating envelope.

37. The method of claim 32, further comprising altering the operating envelope by pivoting the flippers with respect to the chassis to maintain the center of gravity of the entire robot inside the operating envelope.

38. The method of claim 31, further comprising:
determining a deck offset angle of the payload deck relative to at least one of a longitudinal axis of the chassis and the work surface; and
maintaining the payload deck within a threshold angle of at least one of the longitudinal axis of the chassis and the work surface.

39. The method of claim 31, further comprising:
running multiple applications on a processor, each application having a robot controller and an action selection engine, each application being in communication with at least one behavior and at least one action model of at least part of the robot; and
running periodic action selection cycles on each action selection engine, each action selection cycle comprising:
selecting a command for each action space of each action model;
generating a single overall command based on the accumulated commands for each action model; and
sending the overall command to the robot controller for execution on the robot.

40. A method of controlling a robot to negotiate steps, the method comprising:
assuming a stair negotiation start pose by:
moving right and left driven flippers disposed on corresponding sides of a chassis of the robot to a deployed position, each flipper having a pivot end, a distal end, and a center of gravity therebetween, and each flipper being pivotable about a first pivot axis common with a drive axis at the leading end of the chassis, the chassis having a leading end, a trailing end, and a center of gravity therebetween, the deployed flippers positioned in front of and at an angle with respect to the chassis; and
moving a center of gravity of the entire robot to a stable position;
assuming a stair advancement pose by positioning a center of gravity of a payload deck forward of the center of gravity of the chassis and above the center of gravity of the flippers; and
maintaining a dive direction along a stair direction.

41. The method of claim 40, wherein assuming the stable position comprises moving the payload deck to a parked position adjacently above the chassis.

42. The method of claim 40, wherein assuming the stable position comprises moving centers of gravity of the payload deck and the deck shifter forward of the center of gravity of the chassis and rearward of the center of gravity of the flippers.

43. The method of claim 40, wherein assuming the stair advancement pose further comprises positioning the center of gravity of the payload deck forward of the center of gravity of the flippers.

44. The method of claim 40, wherein maintaining a dive direction comprises limiting a commanded turn rate to a threshold turn rate away from the stair direction.
